(19) United States
(12) Patent Application Publication
(10) Pub. No.: US 2020/0059784 A1
(43) Pub. Date: Feb. 20, 2020

(54) AUTHENTICATION OF WIRELESS COMMUNICATIONS

(71) Applicant: QUALCOMM Incorporated, San Diego, CA (US)

(72) Inventors: Mayank Batra, Cambridge (GB); Srivathsa Sridhara, Bhadravathi (IN)

(21) Appl. No.: 16/127,130

(22) Filed: Sep. 10, 2018

(30) Foreign Application Priority Data
Aug. 17, 2018 (IN) 201841030852

(51) Int. Cl. H04W 12/06; H04W 12/04; H04L 9/32; H04L 9/08

(52) U.S. Cl. CPC H04W 12/06; H04L 9/0861; H04L 9/3271; H04W 12/04

(57) ABSTRACT

This disclosure provides systems, devices, apparatus and methods, including computer programs encoded on storage media, for authenticating data transmissions using backchannel techniques. Some implementations more specifically relate to authenticating broadcast isochronous communications between unconnected wireless communication devices using backchannel challenge and response exchanges. Some implementations involve the generation and verification of a secret code based on an authentication token and a shared secret key. The authentication token and secret code may be exchanged via a backchannel between unconnected broadcasting and receiving devices to authenticate a broadcast isochronous stream.

### PRIORITY INFORMATION

This application claims the benefit of priority under § 35 U.S.C. 119(a) to Indian Patent Application Serial No. 201841030852 (Attorney Docket No. 1818241N1) entitled “Authentication of Wireless Communications” and filed 17 Aug. 2018.

### TECHNICAL FIELD

This disclosure relates generally to wireless communications, and more specifically, to authenticating data transmissions using backchannel techniques.

### DESCRIPTION OF THE RELATED TECHNOLOGY

In some configurations, a wireless communication device may broadcast data in a unidirectional, connectionless manner to multiple receiving devices. Broadcasting enables a device to disseminate data to a virtually unlimited number of receiving devices. To this end, the broadcasting device may operate in a connectionless mode with respect to the receiving devices. Broadcasting modes of transferring data may be especially susceptible to attacks and authentication challenges. The broadcaster of data must generate and transmit synchronization information to receiving devices to enable the receiving devices to acquire and decrypt the data. The synchronization information may include a Group Initialization Vector (GIV) and a Group Session Key Diversifier (GSKD). The broadcasting device may also generate a Group Long Term Key (GLTK) that is then distributed to the receiving devices. Each of the broadcasting and receiving devices may generate a Group Session Key (GSK) based on the GLTK and the GSKD.

The GLTK and the GSK are generally secure but the GSKD and the GIV are generally not; they are ascertainable by other devices, including would-be attackers, by capturing the packets in which they are transported. A would-be attacker may abuse the GLTK by pretending to be the genuine broadcasting device. The impostor or “spoofing device” may then select its own GIV and GSKD and begin transmitting data to the other receiving devices. Such data transfer systems are also susceptible to replay attacks. In some applications, the broadcasting device may use an incrementing payload counter as a nonce for encrypting the data to prevent replay attacks. However, even in instances in which a payload counter is utilized, it is still possible for an attacker to capture the GSKD and the GIV. The attacker may then capture encrypted packets and replay them at a later time giving rise to a replay attack. The attack is made possible because the broadcasting device is solely responsible for computing or otherwise determining the GSKD and the GIV; that is, the broadcasting device does not use input from the receiving devices to generate the encryption key used to encrypt the broadcast data.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication. In some implementations, the method includes obtaining a key for wireless communications and receiving synchronization information from a second wireless communication device via a forward channel. The method also includes generating a nonce, generating an authentication token based on a combination of the nonce and at least a portion of the synchronization information, and generating a secret code based on the key and the authentication token. The method additionally includes transmitting a challenge request to the second wireless communication device via a backward channel, the challenge request including the authentication token. Responsive to receiving a challenge response from the second wireless communication device via the backward channel, the method further includes determining whether the challenge response includes the secret code, and authenticating the second wireless communication device based on the determination. Responsive to receiving a wireless communication from the second wireless communication device via a forward channel, the method further includes processing the received wireless communication based on the result of the authentication.

Another innovative aspect of the subject matter described in this disclosure can be implemented in a wireless communication device. In some implementations, the wireless communication device includes at least one processor and at least one memory communicatively coupled with the at least one processor and storing processor-readable code that, when executed by the at least one processor, causes the wireless communication device to perform various operations. In some implementations, the code is configured to cause the wireless communication device to obtain a key for wireless communications. The code also is configured to cause the wireless communication device to receive synchronization information from a second wireless communication device via a forward channel. The code is additionally configured to cause the wireless communication device to generate a nonce, generate an authentication token based on a combination of the nonce and at least a portion of the synchronization information, and generate a secret code based on the key and the authentication token. The code is further configured to cause the wireless communication device to transmit a challenge request to the second wireless communication device via a backward channel, the challenge request including the authentication token. The code is further configured to cause the wireless communication device to, responsive to receiving a challenge response from the second wireless communication device via the backward channel, determine whether the challenge response includes the secret code, and authenticate the second wireless communication device based on the determination. The code is further configured to cause the wireless communication device to, responsive to receiving a wireless communication from the second wireless communication device via a forward channel, process the received wireless communication based on the result of the authentication.

Another innovative aspect of the subject matter described in this disclosure can be implemented in a method for wireless communication. In some implementations, the method includes generating a key for wireless communications. The method also includes generating synchronization information for the wireless communications and transmitting the synchronization information via a forward channel. The method additionally includes receiving a challenge request from a second wireless communication device via a backward channel, the challenge request including an authentication token, the authentication token being based on a combination of a nonce and at least a portion of the synchronization information. The method further includes generating a secret code based on the key and the authentication token and transmitting a challenge response that includes the secret code to the second wireless communication device via the backward channel. The method further includes transmitting at least one wireless communication via a forward channel.

Another innovative aspect of the subject matter described in this disclosure can be implemented in a wireless communication device. In some implementations, the wireless communication device includes at least one processor and at least one memory communicatively coupled with the at least one processor and storing processor-readable code that, when executed by the at least one processor, causes the wireless communication device to perform various operations. In some implementations, the code is configured to cause the wireless communication device to generate a key for wireless communications. The code also is configured to cause the wireless communication device to generate synchronization information for the wireless communications and to transmit the synchronization information via a forward channel. The code is additionally configured to cause the wireless communication device to receive a challenge request from a second wireless communication device via a backward channel, the challenge request including an authentication token, the authentication token being based on a combination of a nonce and at least a portion of the synchronization information. The code is additionally configured to cause the wireless communication device to generate a secret code based on the key and the authentication token and to transmit a challenge response that includes the secret code to the second wireless communication device via the backward channel. The code is further configured to cause the wireless communication device to transmit at least one wireless communication via a forward channel.

In some implementations of the methods, wireless communication devices and computer-readable storage media, the wireless communications are broadcast isochronous packets and receiving the at least one wireless communication includes synchronizing, based on the synchronization information, with a broadcast isochronous stream to receive at least one broadcast isochronous packet. In some implementations of the methods, wireless communication devices and computer-readable storage media, the key is a Group Long Term Key (GLTK), and the portion of the synchronization information includes a Group Session Key Diversifier (GSKD) and a Group Initialization Vector (GIV). In some implementations of the methods, wireless communication devices and computer-readable storage media, generating the authentication token based on the combination of the nonce and the portion of the synchronization information includes forming a concatenation of the nonce, the GSKD and the GIV. In some implementations of the methods, wireless communication devices and computer-readable storage media, generating the secret code based on the key and the authentication token includes hashing the authentication token with a hash function using the GLTK to generate a hash, the secret code being, or being based on, the hash.

In some implementations of the methods, wireless communication devices and computer-readable storage media, the received at least one wireless communication is encrypted. In some such implementations, the methods, wireless communication devices and computer-readable storage media may be configured to generate a Group Session Key (GSK) for the wireless communications based on the GLTK and the GSKD and decrypt the received at least one wireless communication using the GSK.

In some implementations of the methods, wireless communication devices and computer-readable storage media, the forward channel is an isochronous channel and receiving the synchronization information includes receiving the synchronization information in at least one periodic advertising packet transmitted via a secondary advertising channel.

In some implementations of the methods, wireless communication devices and computer-readable storage media, responsive to not receiving the challenge response via the backward channel within an expiration time, the methods, wireless communication devices and computer-readable storage media are configured to initiate a backoff operation, generate a second nonce, generate a second authentication token based on a combination of the second nonce and at least the portion of the synchronization information, generate a second secret code based on the key and the second authentication token, and responsive to the completion of the backoff operation, transmit a second challenge request to the second wireless communication device via the backward channel, the second challenge request including the second authentication token.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a block diagram of an example wireless access point (AP) for use in wireless communication.

FIG. 3 shows a block diagram of an example wireless station (STA) for use in wireless communication.

FIG. 4 shows a pictorial diagram of another example wireless communication network.

FIG. 5 shows a timing diagram illustrating a broadcast isochronous channel and a plurality of advertising channels capable of use by a station (STA) of the wireless communication network of FIG. 4.

FIG. 6 shows a block diagram of an example STA capable of use in the wireless communication network of FIG. 4.

FIG. 7 shows a flowchart illustrating an example process for wireless communication by a receiving device according to some implementations.

FIG. 8 shows a timing diagram illustrating a broadcast isochronous channel and a plurality of advertising channels.

FIG. 9 shows a timing diagram illustrating transmissions between two wireless communication devices.

FIG. 10 shows a timing diagram illustrating transmissions between two wireless communication devices.

FIG. 11 shows a flowchart illustrating an example process for wireless communication by a scanning device according to some implementations.

FIG. 12 shows a flowchart illustrating an example process for wireless communication by a transmitting device according to some implementations.

FIG. 13 shows a block diagram of an example wireless communication device according to some implementations.

FIG. 14 shows a block diagram of an example wireless communication device according to some implementations.

FIG. 15 shows an example protocol data unit (PDU) usable for communicating via a backchannel according to some implementations.

Like reference numbers and designations in the various drawings indicate like elements.

### DETAILED DESCRIPTION

The following description is directed to certain implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G standards, among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal frequency division multiple access (OFDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

Various implementations relate generally to wireless communications, and more specifically, to authenticating data transmissions using backchannel techniques. Some implementations more specifically relate to authenticating broadcast isochronous communications between unconnected wireless communication devices using backchannel challenge and response exchanges. Some implementations involve the generation and verification of a secret code based on an authentication token and a shared secret key. The authentication token and secret code may be exchanged via a backchannel between unconnected broadcasting and receiving devices to authenticate a broadcast isochronous stream.

Particular implementations of the subject matter described in this disclosure can be implemented to realize one or more of the following potential advantages. In some implementations, the described techniques can be used to authenticate wireless communications including broadcast isochronous data transmissions. For example, the described authentication techniques can be used to perform real-time, on-demand authentication using backchannel techniques. Additionally, various implementations provide scalability to a virtually unlimited number of receiving devices because the authentication techniques do not rely on forming connections between the broadcasting device and the receiving devices.

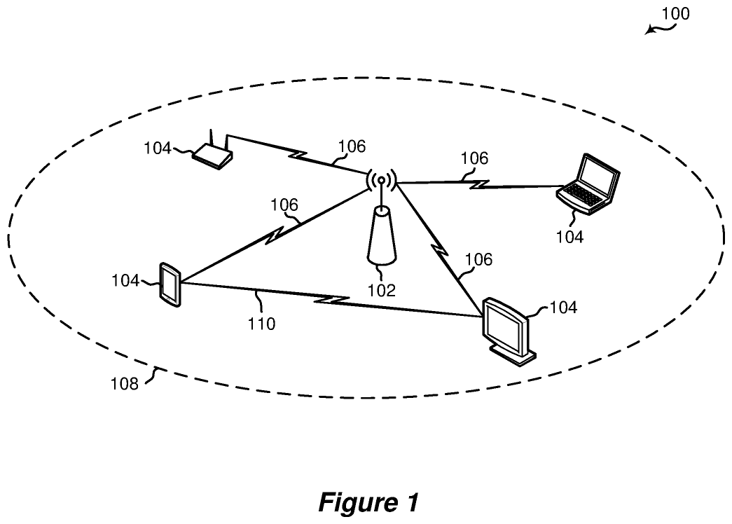

FIG. 1 shows a pictorial diagram of an example wireless communication network 100. In various implementations, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of standards (such as that defined by the IEEE 802.11-2016 specification or amendments thereof). The WLAN 100 may include numerous wireless communication devices such as an access point (AP) 102 and multiple stations (STAs) 104. Each of the STAs 104 also may be referred to as a mobile station (MS), a mobile device, a mobile handset, a wireless handset, an access terminal (AT), a user equipment (UE), a subscriber station (SS), or a subscriber unit, among other possibilities. The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, copiers, kitchen or other household appliances, key fobs (for example, for passive keyless entry and start (PKES) systems), among other possibilities.

A single AP 102 and an associated set of STAs 104 may be referred to as a basic service set (BSS), which is managed by the respective AP. The BSS is identified by a service set identifier (SSID) that is advertised by the AP 102. The AP 102 periodically broadcasts beacon frames (“beacons”) to enable any STAs 104 within wireless range of the AP 102 to establish and/or maintain a respective communication link 106 (hereinafter also referred to as a “Wi-Fi link”) with the AP. The various STAs 104 in the WLAN are able to communicate with external networks as well as with one another via the AP 102 and respective communication links 106. To establish a communication link 106 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU is equal to 1024 microseconds (s)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans, and to perform authentication and association operations to establish a Wi-Fi link with the selected AP.

FIG. 1 additionally shows an example coverage area 108 of the AP 102, which may represent a basic service area (BSA) of the WLAN 100. While only one AP 102 is shown, the WLAN network 100 can include multiple APs 102. As a result of the increasing ubiquity of wireless networks, a STA 104 may have the opportunity to select one of many BSSs within range of the STA and/or select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP with which to associate. For example, a STA 104 that is moving relative to its associated AP 102 may perform a “roaming” scan to find another AP having more desirable network characteristics such as a greater received signal strength indicator (RSSI).

The APs 102 and STAs 104 may function and communicate (via the respective communication links 106) according to the IEEE 802.11 family of standards (such as that defined by the IEEE 802.11-2016 specification or amendments thereof including, but not limited to, 802.11ah, 802.11ay, 802.11ax, 802.11az, and 802.11ba). These standards define the WLAN radio and baseband protocols for the PHY and medium access control (MAC) layers. The APs 102 and STAs 104 transmit and receive frames (hereinafter also referred to as “Wi-Fi communications”) to and from one another in the form of physical layer convergence protocol (PLCP) protocol data units (PPDUs). Each PPDU is a composite frame that includes a PLCP preamble and header as well as one or more MAC protocol data units (MPDUs).

The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the APs 102 and STAs 104 described herein also may communicate in other frequency bands, such as the 6 GHz band, which may support both licensed and unlicensed communications. The APs 102 and STAs 104 also can be configured to communicate over other frequency bands such as shared licensed frequency bands, where multiple operators may have a license to operate in the same or overlapping frequency band or bands.

Each of the frequency bands may include multiple sub-bands or frequency channels. For example, PPDUs conforming to the IEEE 802.11n, 802.11ac and 802.11ax standard amendments may be transmitted over the 2.4 and 5 GHz bands, each of which is divided into multiple 20 MHz channels. As such, these PPDUs are transmitted over a physical channel having a minimum bandwidth of 20 MHz. But larger channels can be formed through channel bonding. For example, PPDUs conforming to the IEEE 802.11n, 802.11ac and 802.11ax standard amendments may be transmitted over physical channels having bandwidths of 40 MHz, 80 MHz or 160 MHz by bonding together two or more 20 MHz channels. Additionally, in some implementations the AP 102 can transmit PPDUs to multiple STAs 104 simultaneously using one or both of multi user (MU) multiple-input multiple-output (MIMO) (also known as spatial multiplexing) and orthogonal frequency division multiple access (OFDMA) schemes.

Each PPDU typically includes a PLCP preamble, a PLCP header and a MAC header prior to the accompanying data. The information provided in the preamble and headers may be used by a receiving device to decode the subsequent data. A legacy portion of the preamble may include a legacy short training field (STF) (L-STF), a legacy LTF (L-LTF), and a legacy signaling field (L-SIG). The legacy preamble may be used for packet detection, automatic gain control and channel estimation, among other uses. The legacy preamble may also be used to maintain compatibility with legacy devices. In instances in which PPDUs are transmitted over a bonded channel, the L-STF, L-LTF, and L-SIG fields may be duplicated and transmitted in each of the plurality of component channels. For example, in IEEE 802.11n, 802.11ac or 802.11ax implementations, the L-STF, L-LTF, and L-SIG fields may be duplicated and transmitted in each of the component 20 MHz channels. The format of, coding of, and information provided in the non-legacy portion of the preamble is based on the particular IEEE 802.11 protocol.

The AP 102, as well as some capable STAs 104, may support beamforming. For example, the AP 102 may use multiple antennas or antenna arrays to conduct beamforming operations for directional communications with a STA 104, and vice versa. Beamforming (which may also be referred to as spatial filtering or directional transmission) is a signal processing technique that may be used at a transmitter (for example, AP 102) to shape and/or steer an overall antenna transmission beam in the direction of a target receiver (for example, a STA 104). Beamforming may be achieved by combining elements in an antenna array in such a way that transmitted signals at particular angles experience constructive interference while others experience destructive interference. In some cases, the ways in which the elements of the antenna array are combined at the transmitter may depend on channel state information (CSI) associated with the channels over which the AP 102 may communicate with the STA 104. That is, based on this CSI, the AP 102 may appropriately weight the transmissions from each antenna (for example or antenna port) such that the desired beamforming effects are achieved. In some cases, these weights may be determined before beamforming can be employed. For example, the transmitter (the AP 102) may transmit one or more sounding packets (for example, a null data packet) to the receiver in order to determine CSI.

In some cases, aspects of transmissions may vary based on a distance between a transmitter (for example, AP 102) and a receiver (for example, STA 104). WLAN 100 may otherwise generally benefit from AP 102 having information regarding the location of the various STAs 104 within coverage area 108. In some examples, relevant distances may be computed using RTT-based ranging procedures. As an example, WLAN 100 may offer such functionality that produces accuracy on the order of one meter (or even centimeter-level accuracy). The same (or similar) techniques employed in WLAN 100 may be applied across other radio access technologies (RATs).

Some types of STAs 104 may support automated communication. Automated wireless devices may include those implementing internet-of-things (IoT) communication, Machine-to-Machine (M2M) communication, or machine type communication (MTC). IoT, M2M or MTC may refer to data communication technologies that allow devices to communicate without human intervention. For example, IoT, M2M or MTC may refer to communications from STAs 104 that integrate sensors or meters to measure or capture information and relay that information to a central server or application program that can make use of the information, enable automated behavior of machines, or present the information to humans interacting with the program or application. Examples of applications for such devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) connections. In some cases, ad hoc networks may be implemented within a larger wireless network such as the WLAN 100. In such implementations, while the STAs 104 may be capable of communicating with each other through the AP 102 using communication links 106, STAs 104 also can communicate directly with each other via direct wireless links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 110 include Wi-Fi Direct connections, connections established by using a Wi-Fi Tunneled Direct Link Setup (TDLS) link, and other P2P group connections.

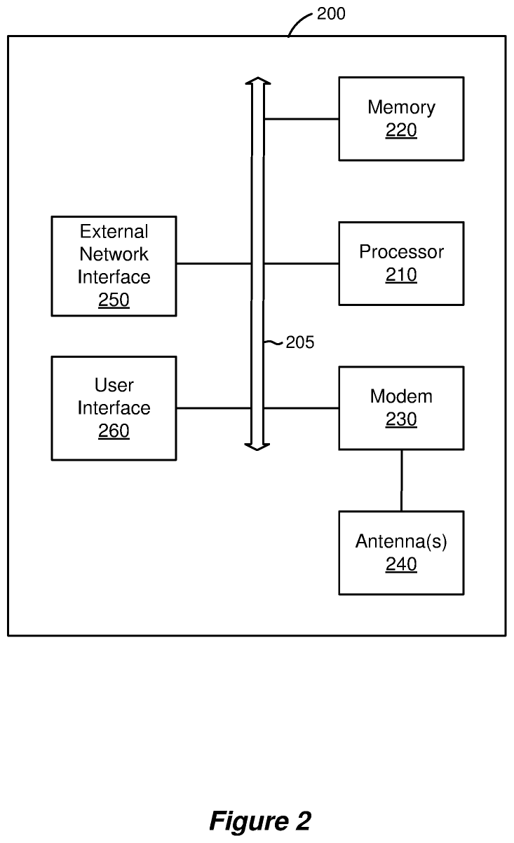

FIG. 2 shows a block diagram of an example access point (AP) 200 for use in wireless communication. For example, the AP 200 may be an example implementation of the AP 102 described with reference to FIG. 1. The AP 200 is capable of transmitting and receiving wireless communications (for example, in the form of wireless packets), as well as of encoding and decoding such communications. For example, the wireless communications can include Wi-Fi packets including frames conforming to an IEEE 802.11 standard (such as that defined by the IEEE 802.11-2016 specification or amendments thereof including, but not limited to, 802.11ah, 802.11ay, 802.11ax, 802.11az, and 802.11ba). The AP 200 includes at least one processor 210 (collectively “the processor 210”), at least one memory 220 (collectively “the memory 220”), at least one modem 230 (collectively “the modem 230”), at least one antenna 240 (collectively “the antenna 240”), at least one external network interface 250 (collectively “the network interface 250”) and, in some instances, a user interface (UI) 260. Each of the components (or “modules”) described with reference to FIG. 2 can communicate with other ones of the components, directly or indirectly, over at least one bus 205.

The processor 210 can include an intelligent hardware device such as, for example, a central processing unit (CPU), a microcontroller, an application-specific integrated circuit (ASIC), or a programmable logic device (PLD) such as a field programmable gate array (FPGA), among other possibilities. The processor 210 processes information received through the modem 230 and the external network interface 330. The processor 210 also can process information to be sent to the modem 230 for transmission through the antenna 240 and information to be sent to the external network interface 250. The processor 210 can generally be configured to perform various operations related to generating and transmitting downlink (DL) frames and receiving uplink (UL) frames.

The memory 220 can include random access memory (RAM) and read-only memory (ROM). The memory 220 also can store processor- or computer-executable software (SW) code containing instructions that, when executed by the processor 210, cause the processor to perform various functions described herein for wireless communication, including generation and transmission of a DL frame and reception of an UL frame.

The modem 230 is generally configured to modulate packets and to provide the modulated packets to the antenna 240 for transmission, as well as to demodulate packets received from the antenna 240 to provide demodulated packets. The modem 230 generally includes or is coupled with at least one radio frequency (RF) transmitter and at least one RF receiver, which may be combined into one or more transceivers, and which are in turn coupled to one or more respective antennas 240. For example, in some AP implementations, the AP 200 can include multiple transmit antennas (each with a corresponding transmit chain) and multiple receive antennas (each with a corresponding receive chain). The modem 230 can communicate bi-directionally, via the antenna 240, with at least one STA (such as the STA 104 described with reference to FIG. 1).

The modem 230 may include digital signal processing (DSP) circuitry, an automatic gain control (AGC), a demodulator, a decoder and a demultiplexer. The digital signals received from the transceivers are provided to the DSP circuitry. The DSP circuitry is configured to acquire a received signal from the digital signals, for example, by detecting the presence of the signal and estimating the initial timing and frequency offsets. The DSP circuitry is further configured to digitally condition the digital signals, for example, by performing channel (narrowband) filtering, performing analog impairment conditioning (such as correcting for I/Q imbalance), and by applying digital gain to ultimately obtain a narrowband signal. The output of the DSP circuitry is fed to the AGC, which is configured to use information extracted from the digital signals, for example, in one or more received training fields, to determine an appropriate gain. The output of the DSP circuitry also is coupled with the demodulator, which is configured to extract modulated symbols from the narrowband signal and to reverse map the symbols to points in a modulation constellation to provide demodulated bits. The demodulator is coupled with the decoder, which is configured to decode the demodulated bits to provide decoded bits, which are then fed to the demultiplexer for demultiplexing. The demultiplexed bits may then be provided to the processor 210 for processing, evaluation or interpretation, for example, by one or more host applications executing on the processor.

The AP 200 may communicate with a core or backhaul network through the external network interface 250 to gain access to external networks including the Internet. For example, the external network interface 250 may include one or both of a wired network interface (for example, an Ethernet interface) or a wireless wide area network (WWAN) interface (for example, including a cellular interface such as an LTE, 4G or 5G interface).

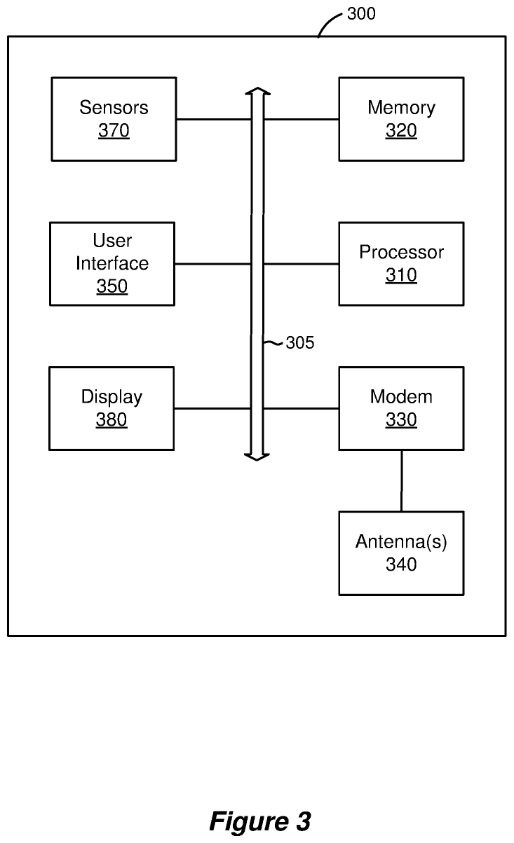

FIG. 3 shows a block diagram of an example wireless station (STA) 300 for use in wireless communication. For example, the STA 300 may be an example implementation of the STA 104 described with reference to FIG. 1. The STA 300 is capable of transmitting and receiving wireless communications, as well as of encoding and decoding such communications. The wireless communications may conform to any of a number of different wireless communication protocols. For example, the STA 300 may be capable of transmitting and receiving Wi-Fi packets including frames conforming to an IEEE 802.11 standard, such as defined by the IEEE 802.11-2016 specification or amendments thereof including, but not limited to, 802.11ah, 802.11ay, 802.11ax, 802.11az, and 802.11ba). Additionally or alternatively, the STA 300 may be capable of transmitting and receiving Bluetooth packets conforming to a Bluetooth standard, such as defined in IEEE 802.15 or by the Bluetooth SIG. Additionally or alternatively, the STA 300 may be capable of transmitting and receiving wireless packets associated with the Long Term Evolution (LTE), International Mobile Telecommunications-Advanced (IMT-Advanced) 4G or 5G standards.

The STA 300 includes at least one processor 310 (collectively “the processor 310”), at least one memory 320 (collectively “the memory 320”), at least one modem 330 (collectively “the modem 330”) and at least one antenna 340 (collectively “the antenna 340”). In some implementations, the STA 300 additionally includes some or all of the following: a user interface (UI) 350 (such as a touchscreen or keypad), one or more sensors 370 (such as one or more inertial sensors, accelerometers, temperature sensors, pressure sensors, or altitude sensors), and a display 380. Each of the components (or “modules”) described with reference to FIG. 3 can communicate with one another, directly or indirectly, over at least one bus 305.

The processor 310 includes an intelligent hardware device such as, for example, a CPU, a microcontroller, an ASIC or a PLD such as an FPGA, among other possibilities. The processor 310 processes information received through the modem 330 as well as information to be sent to the modem 330 for transmission through the antenna 340. The processor 310 can be configured to perform various operations related to receiving a downlink frame and generating and transmitting an uplink frame.

The memory 320 can include RAM and ROM. The memory 320 also can store processor- or computer-executable SW code containing instructions that, when executed, cause the processor 310 to perform various functions described herein for wireless communication, including reception of a downlink frame and generation and transmission of an uplink frame.

The modem 330 is generally configured to modulate packets and provide the modulated packets to the antenna 340 for transmission, as well as to demodulate packets received from the antenna 340 to provide demodulated packets. The modem 330 generally includes at least one radio frequency (RF) transmitter and at least one RF receiver, which may be combined into one or more transceivers, and which are in turn coupled to one or more respective antennas 340. For example, in some implementations, the STA 300 can include multiple transmit antennas (each with a corresponding transmit chain) and multiple receive antennas (each with a corresponding receive chain). The modem 330 can communicate bi-directionally, via the antenna 340, with at least one AP (such as the AP 102 or AP 200 described with reference to FIGS. 1 and 2, respectively). As is described above, in some implementations, the modem also can communicate bi-directionally, via the antenna 340, with other STAs directly without the use of an intermediary AP.

The modem 330 may include DSP circuitry, an AGC, a demodulator, a decoder and a demultiplexer. The digital signals received from the transceivers are provided to DSP circuitry configured to acquire a received signal from the digital signals, for example, by detecting the presence of the signal and estimating the initial timing and frequency offsets. The DSP circuitry is further configured to digitally condition the digital signals, for example, by performing channel (narrowband) filtering, performing analog impairment conditioning (such as correcting for I/Q imbalance), and by applying digital gain to ultimately obtain a narrowband signal. The output of the DSP circuitry is fed to the AGC, which is configured to use information extracted from the digital signals, for example, in one or more received training fields, to determine an appropriate gain. The output of the DSP circuitry also is coupled with the demodulator, which is configured to extract modulated symbols from the narrowband signal and to reverse map the symbols to points in a modulation constellation to provide demodulated bits. The demodulator is coupled with the decoder, which is configured to decode the demodulated bits to provide decoded bits, which are then fed to the demultiplexer for demultiplexing. The demultiplexed bits may then be provided to the processor 310 for processing, evaluation or interpretation, for example, by one or more host applications executing on the processor.

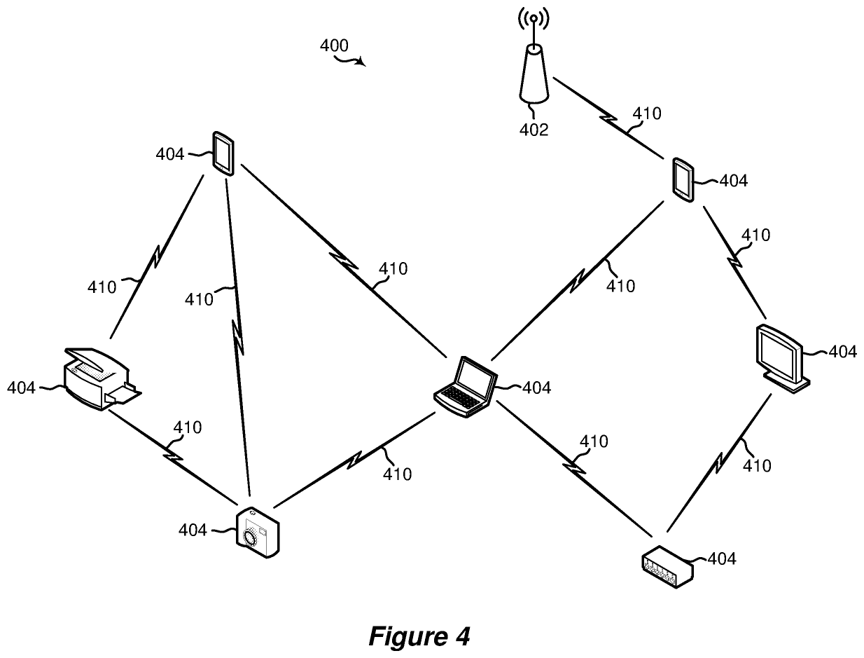

FIG. 4 shows a pictorial diagram of another example wireless communication network 400. In various implementations, the wireless communication network 400 can be an example of a wireless local area network (WLAN) or a wireless personal area network (PAN). The wireless communication network (hereinafter “wireless network”) 400 may include multiple wireless communication devices including STAs 404. For example, some STAs 404 may be implementations of the STAs 104 or 300 described with reference to FIGS. 1 and 3, respectively. Each of the STAs 404 also may be referred to as a mobile station (MS), a mobile device, a mobile handset, a wireless handset, an access terminal (AT), a user equipment (UE), a subscriber station (SS), or a subscriber unit, among other possibilities. The STAs 204 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, copiers, kitchen or other household appliances, key fobs (for example, for passive keyless entry and start (PKES) systems), among other possibilities.

The wireless network 400 is an example of an ad hoc network. The STAs 404 can communicate directly with one another via wireless links 410. In some implementations, the WLAN 400 is an example of a Bluetooth network and the STAs 404 are Bluetooth-compliant devices. A Bluetooth device can be any device, such as a Bluetooth-compliant STA 404, that implements one or more of the Bluetooth wireless communication protocols as defined by the IEEE 802.15 or Bluetooth Special Interest Group (SIG) standards, for example, including the Bluetooth 4.0 Specification and the Bluetooth 5.0 Specification. Bluetooth refers to a set of short-range wireless communication protocols including the Basic Rate (BR) core configuration, including the Enhanced Data Rate (EDR) configuration, and the Low Energy (LE) core configuration as, for example, defined in Bluetooth SIG Specification Versions 4.0 and 5.0. Both the BR physical (PHY) layer and the LE PHY layer operate in the unlicensed Industrial, Scientific and Medical (ISM) 2.4 GHz short-range radio frequency band (2400-2483.5 MHz) and may utilize frequency-hopping spread spectrum radio technology and shaped, binary frequency modulation.

Bluetooth-compliant STAs 404 (hereinafter “STAs 404”) may transmit and receive Bluetooth communications (for example, in the form of Bluetooth packets) to and from one another over wireless links 410 (hereinafter also referred to as “Bluetooth links”) according to a master/slave architecture. Additionally or alternatively, STAs 404 may transmit and receive Bluetooth packets according to a broadcaster/scanner architecture (as described further below). In the master/slave architecture, one of the STAs 404, referred to as the master, provides clock synchronization to the other STAs 404, which are referred to as slaves. During typical operation, a physical radio channel can be shared by multiple STAs 404 (referred to as a “piconet”). The STAs 404 of a Bluetooth piconet are synchronized to the common clock and frequency (channel) hopping pattern specified by the master. A master STA 404 may have PHY links with multiple slave STAs 404 simultaneously. Similarly, a slave STA 404 may be permitted to have PHY links to more than one master STA 404 at a time. Additionally, a STA 204 may be permitted to have the role of both master and slave at the same time; for example, a STA 404 may be a master as it pertains to a first PHY link with another Bluetooth device while simultaneously being a slave as it pertains to a second PHY link with yet another Bluetooth device.

According to the Bluetooth Specification, packets are communicated via a logical link control and adaptation protocol (L2CAP) channel, which is layered over logical links and logical transports, which are in turn built on physical links, physical channels and physical transports. The BR logical transports include the Synchronous Connection-Oriented (SCO), extended SCO (eSCO), Asynchronous Connection-Less (ACL), Active Slave Broadcast (ASB) and Connectionless Slave Broadcast (CSB) logical transports. Both the synchronous and the asynchronous logical transports may represent point-to-point links between a master STA 404 and a respective slave STA 404. The master STA 404 maintains the synchronous logical transports using reserved time slots at regular intervals to transmit SCO and eSCO packets. The master STA 404 can establish an ACL logic transport on a per-slot basis to transmit ACL packets to any slave STA 404 in the time slots not reserved for SCO and eSCO packets.

The BR PHY supports a BR mode having a bit rate of 1 Mbps, and an EDR mode having a bit rate of 2 or 3 Mbps. Each BR packet (for example, in the form of a protocol data unit (PDU)) generally includes three portions: an access code, a header and a payload (which may have zero length). The access code includes a preamble used for DC offset compensation, a sync word used for timing acquisition and synchronization, and optionally a trailer. The access code is also used for identification purposes; all packets transmitted in a single physical channel share the same access code. The packet header includes the link control information including a logical transport address and a packet type identification. In master-to-slave transmissions, the logical transport address indicates the destination slave STA 404 (or multiple slaves in the case of broadcast transmissions) by which the packet is intended to be received, while in slave-to-master transmissions, the logical transport address indicates the source STA 404 transmitting the packet.

The Bluetooth LE core configuration is particularly designed to enable STAs 404 having relatively lower current consumption, complexity and cost than BR- or EDR-supporting STAs 404. For example, LE may be especially advantageous for use cases and applications requiring lower data rates and duty cycles. LE STAs 404 may support three PHY modes (“PHYs”): LE 1M, LE 2M and LE Coded, supporting bit rates of 1 megabit per second (Mbps), 2 Mbps, and either 125 kilobits per second (kpbs) or 500 kpbs (depending on the coding), respectively. LE supports both frequency division multiple access (FDMA) and time division multiple access (TDMA) schemes. Forty physical channels separated by 2 MHz may be used in the FDMA scheme. For TDMA, a polling scheme is used in which one device transmits at a predetermined time and a corresponding device responds after a predetermined time interval. The LE logical transports include the LE asynchronous connection (LE ACL), LE Advertising Broadcast (ADVB) and LE Periodic Advertising Broadcast (PADVB) logical transports. Each LE packet (PDU) generally includes a preamble, an access address (including an access code), a PDU header and a PDU payload. LE packets may also include a message integrity check (MIC) and a cyclic redundancy check (CRC) following the payload.

In the LE core configuration, several physical channels are defined including advertising, periodic, data and isochronous channels. The physical channels are divided into time units called events during which STAs 404 may communicate with one another. These events may in turn be sub-divided into sub-events (also referred to herein simply as “events”). For example, such events may include advertising events, connection events and isochronous events. STAs 404 transmit particular types of packets associated with particular types of events on particular physical channels. For example, each connection event is initiated by a master STA 404 via a connection creation procedure. Frequency channel hopping can occur at the start of each connection event. Connection events may be used to transmit asynchronous data PDUs (“data packets”) between STAs 404 via data channels.

Advertising events may be used for unidirectional or broadcast communications between STAs 404. For example, advertising events may be used to transmit advertising channel PDUs (“advertising packets”) via one or more advertising channels to establish pair-wise bidirectional communications via data channels, periodic broadcasts via secondary advertising channels, or isochronous broadcasts via isochronous channels. For example, if an advertising device (“advertiser”) is using a connectable advertising event, the initiating device (“initiator”) may make a connection request using the same advertising PHY channel on which it received the advertising packet. If the advertiser receives and accepts the connection request, a connection is established and the initiator becomes the master device while the advertiser becomes a slave device. For example, ADV_EXT_IND and ADV_AUX_IND PDUs (“packets”) may be transmitted during extended advertising events for scanning purposes or to initiate other devices, while AUX_SYNC_IND PDUs (“packets”) may be transmitted during periodic advertising events also for scanning purposes.

Isochronous events may be used to transmit isochronous PDUs (“isochronous packets”) between STAs 404 via isochronous channels. There are two general categories of isochronous communications: those between connected STAs 404 and those between unconnected STAs 404. During an isochronous event exchange between connected STAs 404, master and slave STAs 404 may communicate over a point-to-point logical transport called a Connected Isochronous Stream (CIS) to exchange isochronous data. During an isochronous event exchange between unconnected STAs 204, a broadcasting STA (“broadcaster”) 204 may use a connectionless logical transport called a Broadcast Isochronous Stream (BIS) to broadcast isochronous data in a unidirectional, connectionless manner to multiple receiving STAs 404 referred to as scanning devices (“scanners”) forming a Broadcast Isochronous Group (BIG).

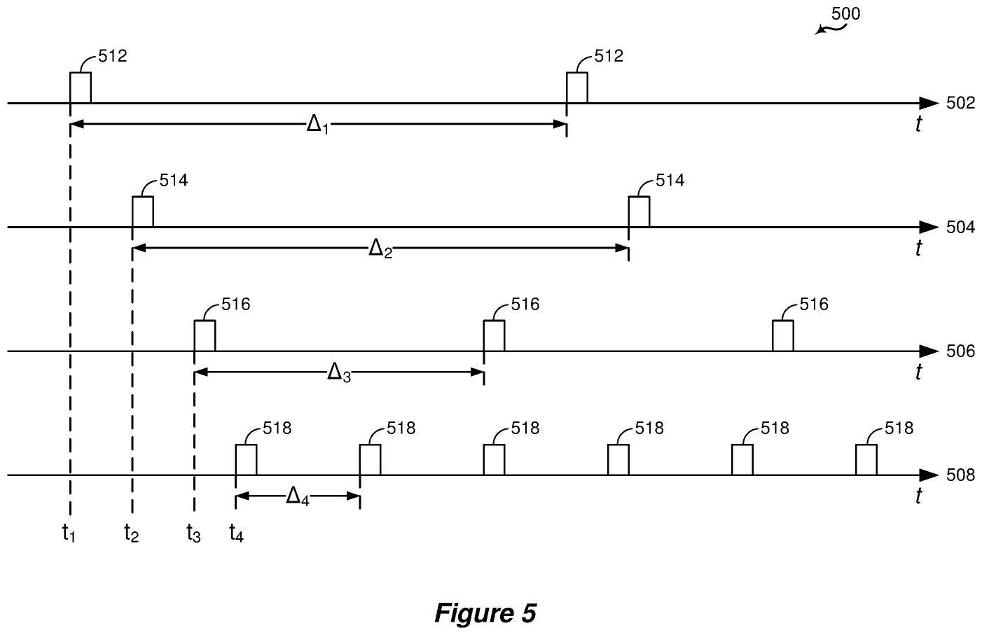

A BIS is defined by multiple events that occur at regular intervals including, for example, extended advertising events, periodic advertising events, and isochronous group events and isochronous stream events. The broadcasting STA 404 periodically broadcasts periodic advertising events that contain synchronization information, including security information and identification information, for the BIS. Other STAs 404 receiving such periodic advertising events can use the synchronization information to synchronize to the BIS and receive the broadcast data (as described in more detail below with reference to FIG. 5). Periodic advertising may allow an unlimited number of scanning STAs 404 to synchronize to a given broadcasting STA 404 and BIS. Periodic advertising events are deterministic in terms of time and frequency, thus leading to power savings at the receiving STAs 404 because they can remain asleep or otherwise in a low power state when not receiving broadcast data and can wake up or otherwise be enabled to listen for the broadcasting STA 404 (the advertiser) at precisely known times during which extended advertising events, periodic advertising events, and isochronous group events and isochronous stream events occur.

The LE isochronous physical channel is characterized by a pseudo-random sequence of PHY channels and by three additional synchronization parameters provided by the broadcasting STA 404, whether it be the master device in a connected configuration or whether it be a connectionless broadcasting device. These synchronization parameters include a channel map that indicates the set of PHY channels used in the piconet, a pseudo random number used as an index into the complete set of PHY channels, and the timing of the first data packet.

FIG. 5 shows a timing diagram 500 illustrating a broadcast isochronous channel and a plurality of advertising channels capable of use by a STA 404 of FIG. 4. In the illustrated implementation, the timing diagram 500 includes a primary advertising channel 502, a secondary advertising channel 504 and a periodic advertising channel 506, in addition to the isochronous channel 508 via which the broadcast isochronous data packets are transmitted. The broadcasting STA 404 broadcasts extended advertising packets 512 via the primary advertising channel 502. For example, each of the extended advertising packets 512 may be an ADV_EXT_IND packet in conformance with the Bluetooth 5.0 Specification. As shown, the broadcasting STA 404 broadcasts an extended advertising packet 512 at time t₁. The broadcasting STA 404 may broadcast subsequent extended advertising packets 512 at regular intervals Δ₁, for example, every second.

Each of these extended advertising packets 512 includes synchronization information enabling scanning STAs 404 to identify, lock onto or otherwise synchronize with the secondary advertising channel 504 to acquire other extended advertising packets 514 that the broadcasting STA 404 broadcasts via the secondary advertising channel 504. For example, each of the extended advertising packets 514 may be an AUX_ADV_IND packet in conformance with the Bluetooth 5.0 Specification. As shown, the broadcasting STA 404 broadcasts an extended advertising packet 514 at time t₂. The broadcasting STA 404 may broadcast subsequent extended advertising packets 514 at regular intervals Δ₂, for example, every second.

Each of these other extended advertising packets 514 includes synchronization information enabling scanning STAs 404 to identify, lock onto or otherwise synchronize with the periodic advertising channel 506 to acquire periodic advertising packets 516 that the broadcasting STA 404 broadcasts via the periodic advertising channel 506. For example, each of the periodic advertising packets 516 may be an AUX_SYNC_IND packet in conformance with the Bluetooth 5.0 Specification. As shown, the broadcasting STA 404 broadcasts a periodic advertising packet 516 at time t₃. The broadcasting STA 404 may broadcast subsequent periodic advertising packets 516 at regular intervals Δ₃, for example, on the order of every second less. Each of periodic advertising packets 516 includes synchronization information enabling scanning STAs 404 to identify, lock onto or otherwise synchronize with the isochronous channel 508 to acquire the isochronous data packets 518 of the BIS that the broadcasting STA 404 broadcasts via the broadcast isochronous channel 508. As shown, the broadcasting STA 404 broadcasts an isochronous data packet 518 at time t₄. The broadcasting STA 404 may broadcast the isochronous data packets 518 at regular intervals Δ₄, for example, on the order of every second or less.

Isochronous data transfer combines features of both synchronous and asynchronous data transfer. For example, in an isochronous data transfer system, each transmission begins with a start packet. Blocks of data are then transmitted asynchronously. Typically, the data must be transmitted with a guaranteed bandwidth to ensure delivery within specified time constraints. As such, isochronous data transfer may be advantageous in applications including voice traffic, streaming video, and streaming audio (for example, between a mobile smartphone and wireless earbuds. However, isochronous data transfer does not include an error detection mechanism such as an acknowledgement packet because, even if an error was detected, time constraints would prohibit the retransmission of the data.

STAs 404 may implement security features for pairing, bonding, authentication, encryption and message integrity. For example, pairing involves generating one or more shared secret keys, bonding involves storing the keys for use in subsequent connections and authentication involves verifying that two devices have the same keys. Encryption may be used to ensure message confidentiality and message integrity may protect against forgeries.

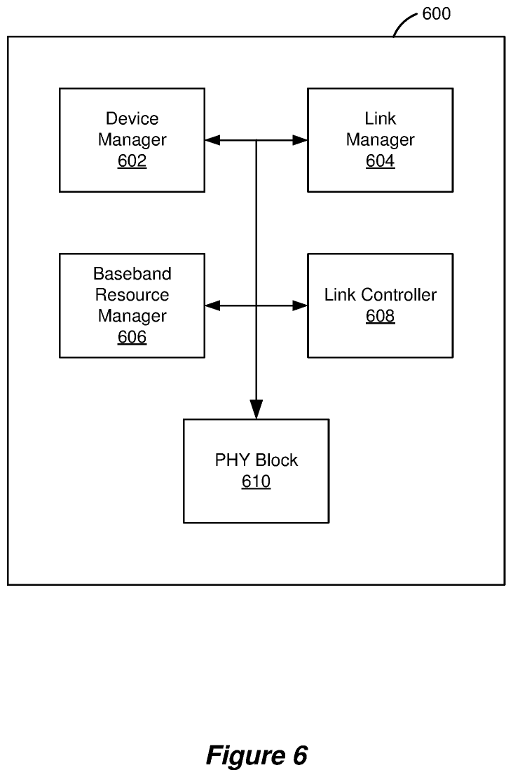

Each STA 404 may generally include several components. FIG. 6 shows a block diagram of an example STA 600 capable of use in the wireless communication network of FIG. 4. For example, the STA 600 may be an example implementation of the STA 404 described with reference to FIG. 4. In the illustrated implementation, the STA 600 includes a device manager 602, a link manager 604, a baseband resource manager 606, a link controller 608 and a PHY block 610, each of which may be implemented by a processor (such as the processor 310), a modem (such as the modem 330), or a combination such components or modules or other components or modules. The device manager 602 controls the general behavior of the Bluetooth system and is responsible for discovery and for connecting to other STAs 600, and generally all operations not directly related to data transport. The link manager 604 is responsible for the creation, modification and termination of logical links (including the associated logical transports) as well as the updating of parameters related to the physical links. The baseband resource manager 606 is responsible for access to the wireless medium and is configured to perform scheduling and to enforce QoS requirements. The link controller 608 is responsible for the encoding and decoding of packets while the PHY block 610 is responsible for the transmission and reception of packets over the physical channels of the wireless medium.

In some examples, a Bluetooth-compliant also may be configured for wireless communication with other networks such as with a Wi-Fi WLAN or a WWAN (for example, a cellular network such as an LTE, 4G or 5G network), which may, in turn, provide access to external networks including the Internet. As such, and as used herein, a wireless communication device, such as one of STAs 404 or 600, may refer to a device that is capable of operating within both a Bluetooth network as well as another type of wireless network, such as a Wi-Fi BSS or within a WWAN cell. To manage coexistence between Bluetooth and WLAN systems, which both operate in the ISM 2.4 GHz band, the use of the shared wireless medium may be time-division multiplexed to ensure that only one of the interfering modems will gain access to the physical wireless medium at any given time. Adaptive frequency hopping also improves coexistence with co-located static (non-hopping) systems.

Broadcast isochronous data transfer systems may be especially susceptible to attacks and authentication challenges. For example, in a connectionless Bluetooth LE implementation using a Broadcast Isochronous Stream (BIS), the broadcaster of the isochronous data must generate and transmit synchronization information to the receiving devices of the Broadcast Isochronous Group (BIG) to enable the receiving devices to acquire the BIS and decrypt the isochronous data. The synchronization information includes, in addition to the synchronization parameters (the channel map, pseudo random number and the timing) described above, security information including a Group Initialization Vector (GIV) and a Group Session Key Diversifier (GSKD). The broadcasting device further generates a Group Long Term Key (GLTK) that is then distributed to the receiving devices. Each of the broadcasting and receiving devices may generate an encryption key—a Group Session Key (GSK)—based on the GLTK and the GSKD.

The GLTK and the GSK are secure but the GSKD and the GIV are not; they are ascertainable by other devices, including would-be attackers, by capturing the periodic advertising packets in which they are transported. Isochronous data transfer systems may thus be susceptible to an abuse of the GLTK. The broadcasting device may distribute the GLTK to receiving devices when pairing with the broadcasting device. Any of these paired devices may then abuse the GLTK by pretending to be the genuine broadcasting device. The impostor or “spoofing device” may then select its own GIV and GSKD and begin broadcasting data to the other receiving devices. Thus, an authentication mechanism is desirable, especially for public announcements in which a large number of receiving devices are expected to be synchronized with the BIS.

Isochronous data transfer systems are also susceptible to replay attacks. In some applications, the broadcasting device may use an incrementing payload counter as a nonce for encrypting the isochronous data transmitted via the BIS to prevent replay attacks. However, even in instances in which a payload counter is utilized, it is still possible for an attacker to capture the periodic advertising packets, and thus ascertain the GSKD and the GIV. The attacker may then capture encrypted broadcast packets and replay them at a later time giving rise to a replay attack. Generally, a receiving device has no way of determining whether received broadcast packets are proper or “fresh” or whether they have been replayed. Notably, the attacker does not need to know the GLTK to perform such a replay attack. Rather, the attack is made possible because the broadcasting device is solely responsible for computing or otherwise determining the GSKD and the GIV; that is, the broadcasting device does not use input from the receiving devices.

Various implementations relate generally to wireless communications, and more specifically, to authenticating data transmissions using backchannel techniques. Some implementations more specifically relate to authenticating broadcast isochronous communications between unconnected wireless communication devices using backchannel challenge and response exchanges. Some implementations involve the generation and verification of a secret code based on an authentication token and a shared secret key. The authentication token and secret code may be exchanged via a backchannel between unconnected broadcasting and receiving devices to authenticate a broadcast isochronous stream.

Particular implementations of the subject matter described in this disclosure can be implemented to realize one or more of the following potential advantages. In some implementations, the described techniques can be used to authenticate wireless communications including broadcast isochronous data transmissions. For example, the described authentication techniques can be used to perform real-time, on-demand authentication using backchannel techniques. Additionally, various implementations provide scalability to a virtually unlimited number of receiving devices because the authentication techniques do not rely on forming connections between the broadcasting device and the receiving devices.

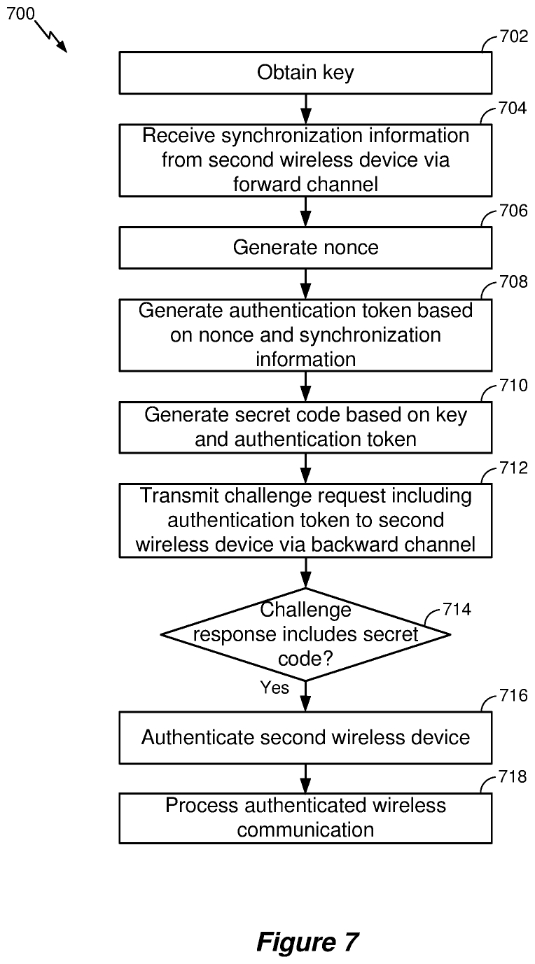

FIG. 7 shows a flowchart illustrating an example process 700 for wireless communication by a receiving device according to some implementations. In some implementations, the process 700 may be performed by a wireless communication device such as one of the STAs 404 or 600 described above with reference to FIGS. 4 and 6, respectively. In some implementations, the process 700 can be implemented by a first wireless communication device (also referred to herein as a “receiving device” or a “scanning device” in some implementations) for use in receiving data broadcast or otherwise transmitted by a second wireless communication device (also referred to herein as a “transmitting device” or a “broadcasting device” in some implementations) in a secure manner.

In some implementations, the process 700 begins in block 702 with obtaining a key for wireless communications. In block 704, the first wireless communication device receives synchronization information (also referred to herein as “synchronization data”) from a second wireless communication device via a forward channel. The process 700 proceeds in block 706 with generating a nonce, and in block 708, with generating an authentication token based on the nonce. In some implementations, the first wireless communication device more specifically generates the authentication token based on a combination of the nonce and at least a portion of the synchronization information. In block 710, the first wireless communication device generates a secret code based on the key and the authentication token. The first wireless communication device then transmits, in block 712, a challenge request including the authentication token to the second wireless communication device via a backchannel (also referred to herein as a “backward channel” or a “reverse channel”).

Responsive to receiving a challenge response via the backchannel, the first wireless communication device determines, in block 714, whether the challenge response includes the secret code generated in block 710. Based on the determination, the first wireless communication device authenticates the second wireless communication device in block 716. For example, based on verifying that the challenge response includes the correct secret code, the first wireless communication device authenticates the second wireless communication device as an authentic transmitter of wireless communications. For example, the first wireless communication device may authenticate that the second wireless communication device is not only the source of the synchronization information but also the source of the secret key. Subsequently, responsive to receiving a wireless communication from the authenticated second wireless communication device via a forward channel, the first wireless communication device processes the received wireless communication in block 718. For example, based on verifying that the source of the received wireless communication is an authenticated source, in this case the second wireless communication device, the first wireless communication device authenticates and processes the received wireless communication.

As a person having ordinary skill in the art will appreciate, although the operations of the process 700 are illustrated and described as ordered blocks or steps, the operations within each of the blocks may be ongoing or periodic and the blocks may overlap or otherwise be rearranged. For example, the second wireless communication device may periodically transmit, and the first wireless communication device may periodically receive, the synchronization information or the wireless communications.

In some implementations, the first and the second wireless communication devices can be configured for broadcast isochronous communications and be part of a BIG that also may include a number of other wireless communication devices. In such implementations, the first wireless communication device may be configured to receive isochronous packets broadcast by the second wireless communication device. For example, the first wireless communication device may receive the wireless communications in the form of a BIS of isochronous data packets. To receive the broadcast isochronous data packets, the first wireless communication device is configured to synchronize with the BIS based on the synchronization information. The second wireless communication device may periodically transmit, and the first wireless communication device may periodically receive, the synchronization information in block 704 in broadcast advertising packets including periodic advertising packets.

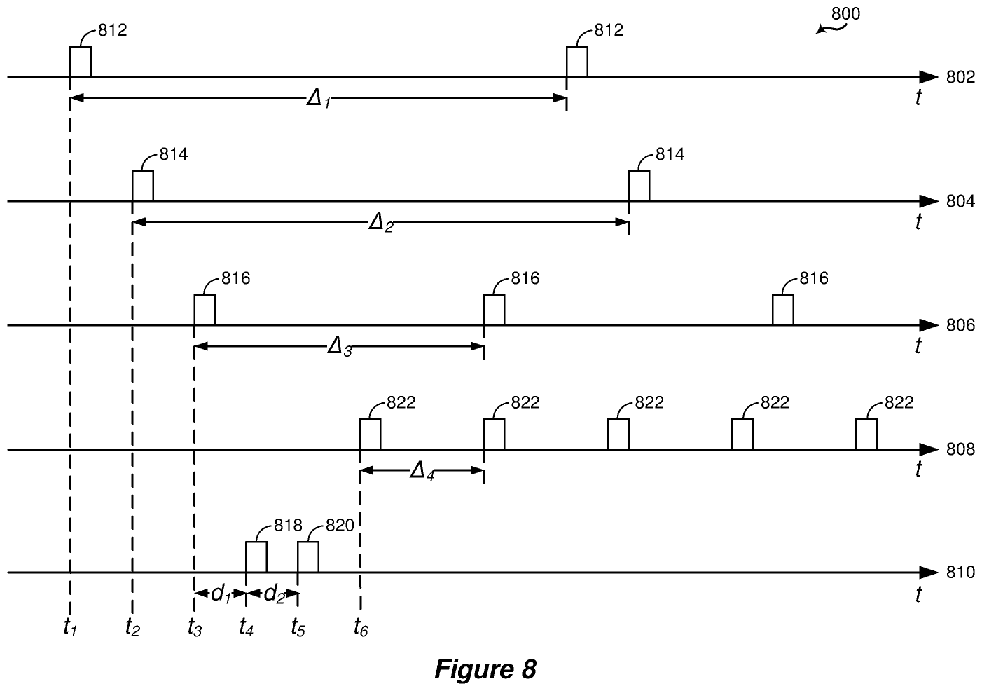

FIG. 8 shows a timing diagram 800 illustrating a broadcast isochronous channel and a plurality of advertising channels. In the illustrated implementation, the timing diagram 800 includes a primary advertising channel 802, a secondary advertising channel 804, a periodic advertising channel 806 and an isochronous channel 808, all of which may be characterized as forward channels. As used herein, a forward channel may refer to a unidirectional channel via which unidirectional communications are transmitted from a broadcasting device to one or more receiving devices. A forward channel is generally defined by a particular frequency or frequencies. A forward channel also may be defined on a temporal basis, for example, by time slot or event boundaries. For example, the primary advertising channel 802 may refer to one or more of a number of frequency channels (currently three in the Bluetooth 5.0 Specification for BLE communications). The wireless communication devices, including the first and the second wireless communication devices, typically hop among the primary channels over the course of a communication session. The secondary advertising channel 804, the periodic advertising channel 806 and the isochronous channel 808 may use one or more of a number of other frequency channels (currently 37 in the Bluetooth 5.0 Specification for BLE communications). Again, the wireless communication devices, including the first and the second wireless communication devices, typically hop among these channels over the course of a communication session.

The timing diagram 800 further includes a backchannel 810. As used herein, a backchannel may refer to a channel that is not related to a corresponding forward channel. The backchannel 810 may utilize the same or different frequency channels as the secondary advertising channel 804, the periodic advertising channel 806 and the isochronous channel 808. However, communications via the backchannel 810 may occur at different times than the times associated with the advertising events, periodic advertising events and isochronous events that define the primary advertising channel 802, the secondary advertising channel 804, the periodic advertising channel 806 and the isochronous channel 808. In some implementations, like the broadcast isochronous communications transmitted via the isochronous channel 808, the backchannel communications also are transmissions between unconnected devices. Additionally, unlike the isochronous channel 808, the backchannel 810 may enable bidirectional communications between transmitting and receiving devices such as between the first wireless communication device and the second wireless communication device.

The second wireless communication device broadcasts extended advertising packets 812 via the primary advertising channel 802. For example, each of the extended advertising packets 812 may be an ADV_EXT_IND packet. As shown, the second wireless communication device broadcasts an extended advertising packet 812 at time t₁. The second wireless communication device may broadcast subsequent extended advertising packets 812 at regular intervals Δ₁, for example, every second. Each of these extended advertising packets 812 includes synchronization information enabling scanning devices such as the first wireless communication device to identify, lock onto or otherwise synchronize with the secondary advertising channel 804 to acquire other extended advertising packets 814 that the second wireless communication device broadcasts via the secondary advertising channel 804. The synchronization information includes identification information such as an advertiser address (also referred to herein as a source address or a transmit address) of the second wireless communication device. The first wireless communication device may receive the extended advertising packet 812 at time t₁ and identify the source of the packet, for example, by inspecting an AdvA address field of the received packet for the address of the source. The synchronization information in the extended advertising packets 812 also can include a pointer in an Aux Ptr field to the extended advertising packets 814, enabling the first wireless communication device to identify the source of the extended advertising packets 814 as well.

For example, each of the extended advertising packets 814 may be an AUX_ADV_IND packet. As shown, the second wireless communication device broadcasts an extended advertising packet 814 at time t₂. The second wireless communication device may broadcast subsequent extended advertising packets 814 at regular intervals Δ₂, for example, every second. Each of these extended advertising packets 814 includes synchronization information enabling scanning devices such as the first wireless communication device to identify, lock onto or otherwise synchronize with the periodic advertising channel 806 to acquire periodic advertising packets 816 that the second wireless communication device broadcasts via the periodic advertising channel 806. The synchronization information includes identification information such as the source address of the second wireless communication device. The first wireless communication device may receive the extended advertising packet 814 at time t₂ and identify the source of the packet, for example, by inspecting an AdvA address field of the received packet for the address of the source. Synchronization information also can be included in a Sync Info field of the received packet, which may point to the periodic advertising packets 816, enabling the first wireless communication device to identify the source of the periodic advertising packets 816 without requiring an AdvA address field or the inspection of an address.

For example, each of the periodic advertising packets 816 may be an AUX_SYNC_IND packet and include a GIV and a GSKD. As shown, the second wireless communication device broadcasts a periodic advertising packet 816 at time t₃. The second wireless communication device may broadcast subsequent periodic advertising packets 816 at regular intervals Δ₃, for example, on the order of every second or less. Each of these periodic advertising packets 816 includes synchronization information enabling scanning devices such as the first wireless communication device to identify, lock onto or otherwise synchronize with the isochronous channel 808 to acquire isochronous data packets 822 of the BIS that the second wireless communication device broadcasts via the isochronous channel 808. The synchronization information includes identification information such as the source address of the second wireless communication device. The first wireless communication device may receive the periodic advertising packet 816 at time t₃ and identify the source of the packet, for example, by inspecting an AdvA address field of the received packet for the address of the source. Synchronization information also can be included in a BIS Info field of the received packet, which may point to the isochronous packets 822, enabling the first wireless communication device to identify the source of the isochronous packets 822 without requiring an AdvA address field or the inspection of an address. As shown, the second wireless communication device broadcasts an isochronous data packet 822 at time t₆. The second wireless communication device may broadcast the isochronous data packets 822 at regular intervals Δ₄, for example, on the order of every second or less.

As described above, the synchronization information for the BIG generally includes information enabling any receiving devices within the BIG to identify, lock onto or otherwise synchronize with the BIS to acquire the isochronous data packets. For example, the synchronization information may include a channel map that indicates the set of PHY channels used in the piconet, a pseudo random number used as an index into the complete set of PHY channels, and the timing of the first isochronous data packet. The synchronization information also includes security information for the BIG, such as, for example, the GIV and the GSKD. The GIV enables the receiving devices in the BIG to decrypt received packets. The GSKD enables the receiving devices within the BIG to generate encryption keys for use in decrypting the received packets, including the isochronous data packets of the BIS.

In some implementations, the second wireless communication device encrypts the isochronous data prior to broadcasting the isochronous data packets. To establish an encryption key for decrypting the isochronous data, the first wireless communication device uses the key obtained in block 702. For example, the key may be a secret key such as the GLTK. In some implementations, the first wireless communication device receives the GLTK during a previous pairing operation with the second wireless communication device or via any other suitable techniques. The first wireless communication device can then generate the encryption key, for example, a GSK, based on the GLTK and the GSKD for use in decrypting the broadcast isochronous data.

In some implementations, the first wireless communication device generates the nonce in block 706 using a random number generator. Additionally or alternatively, the nonce may be generated based on timing information, for example, based on a timestamp, such as a global timestamp, indicating a date and time. In some implementations, the portion of the synchronization information used to generate the authentication token in block 708 includes a combination of the GSKD and the GIV, for example, a concatenation of the GSKD and the GIV. The first wireless communication device may generate the authentication token in block 708 using any suitable techniques. In one example, the authentication token may be, or may be based on, a concatenation of the nonce and the portion of the synchronization information. In some implementations, the first wireless communication device generates the secret code in block 710 by applying a hash function to the authentication token using the secret key (for example, the GLTK). For example, the first wireless communication device may execute a hashing algorithm that takes as input the authentication token and the secret key and that generates a hash of the authentication token using the secret key. In such implementations, the secret code may be, or at least be based on, the hash. In one example, the hash function may be or may be based on the AES-CMAC-128 hash function.

As described above, the first wireless communication device transmits the challenge request including the authentication token to the second wireless communication device via a backchannel in block 712. Referring back to FIG. 8, the timing diagram 800 illustrates the first wireless communication device transmitting the challenge request 818 at time t₄ via the backchannel 810. For example, the first wireless communication device may transmit the challenge request 818 a duration d₁ after receiving the periodic advertising packet at time t₃, for example, after one Time Inter Frame Space (TIFS) after the periodic advertising packet is received. The first wireless communication device may determine that the second wireless communication device is the device to which the challenge requested is to be transmitted by identifying the second wireless communication device as a source of the received synchronization information based on a transmit address included in the periodic advertising packet.

The first wireless communication device may transmit the challenge request in block 712 as a backchannel packet 818 on a contention basis while maintaining a connectionless mode in which the first wireless communication device remains unconnected to the second wireless communication device (the broadcasting device). For example, the first wireless communication device may transmit the backchannel challenge request 818 without establishing a point-to-point asynchronous connection-less (ACL) connection or initiating a connection setup procedure with the second wireless communication device. In some implementations, the backchannel 810 uses the same frequency channel as the periodic advertising channel 806. In some other implementations, the backchannel 810 uses a different frequency than the periodic advertising channel 806 or the isochronous channel 808. In some implementations, the backchannel challenge request 818 may be transmitted in block 712 in the form of a AUX_ADV_IND packet that includes the address of the first wireless communication device in a AdvA address field and that includes the address of the second wireless communication device in a TargetA field. The address of the first wireless communication device may be used by the second wireless communication device to determine which receiving device is attempting to communicate.

Upon receiving the challenge request, the second wireless communication device may then generate a secret code based on the authentication token and the secret key. For example, as described above with respect to the first wireless communication device, the second wireless communication device may hash the authentication token received in the challenge request using the GLTK to obtain the secret code. The second wireless communication device may then generate a challenge response including the hash and transmit the challenge response to the first wireless communication device via the backchannel. The timing diagram 800 of FIG. 8 further illustrates the transmission of a challenge response 820 via the backchannel 810 at time t₅. For example, the challenge response 820 may be received by the first wireless communication device after one TIFS after it transmitted the challenge request. In some implementations, the challenge response serves as an implicit acknowledgement (ACK) of receipt of the challenge request. In some other implementations, the challenge response can include an explicit ACK.

As described above, responsive to receiving the challenge response via the backchannel, the first wireless communication device determines, in block 714, whether the challenge response includes the secret code generated in block 710. For example, the first wireless communication device may compare a hash generated in block 710 with a hash included within the challenge response and determine whether the two hashes are identical, for example, by performing an XOR operation. Any change in the authentication token, even to a single bit, will result in a different hash, as will any change in the key used to generate the hash. Based on the determination, the first wireless communication device authenticates the second wireless communication device in block 716. For example, based on verifying that the challenge response includes the correct secret code, the first wireless communication device authenticates the second wireless communication device as an authentic transmitter of wireless communications. For example, the first wireless communication device may authenticate that the second wireless communication device is not only the source of the synchronization information but also the source of the secret key.

Responsive to receiving a wireless communication via a forward channel, the first wireless communication device identifies a source of the received wireless communication. For example, referring back to FIG. 8, the first wireless communication device may receive an isochronous data packet 822 at time t₆ via the isochronous channel 808 and, responsive to the receipt, identify the source of the received isochronous data packet. The first wireless communication device then determines whether the source of the received wireless communication is an authenticated source. For example, the first wireless communication device may, after or as part of authenticating the second wireless communication device in block 716, store the address of the second wireless communication device in an authenticated device list, table or other data structure that identifies authenticated wireless devices (for example, in a memory such as the memory 320 described with reference to FIG. 3). Responsive to receiving the wireless communication, the first wireless communication device may identify the transmit address identified in the received communication and determine whether the identified address is associated with an authenticated device based on whether the address is included in the authenticated device list. If the address identified in the received wireless communication matches an address in the authenticated device list, the first wireless communication device authenticates and processes the received wireless communication as described above in block 718. For example, processing the received wireless communication may include decrypting, decoding or other operations.

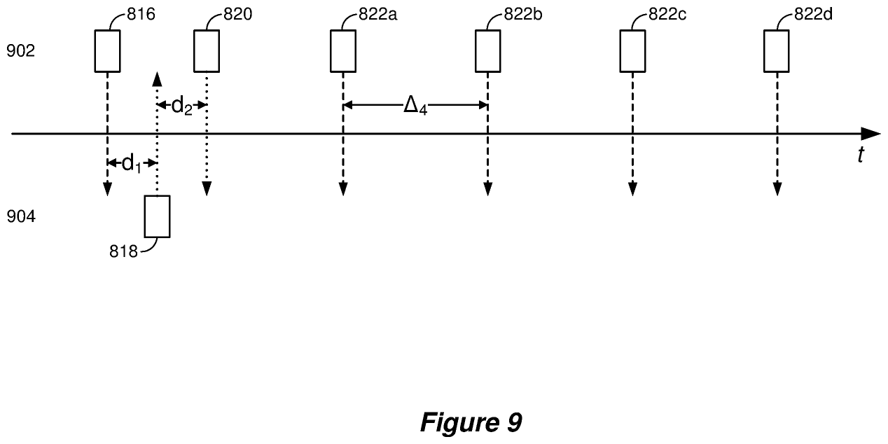

FIG. 9 shows a timing diagram 900 illustrating transmissions between two wireless communication devices. The timing diagram 900 is divided into two portions to show the directions of the transmissions. For example, all transmissions above the horizontal time axis are transmitted by the second wireless communication device (device 902) described with reference to FIGS. 7 and 8, while all transmissions below the time axis are transmitted by the first wireless communication device (device 904). As shown, the first wireless communication device 904 transmits a challenge request 818 a duration d₁ after receiving a periodic advertising packet 816 transmitted by the second wireless communication device 902. The second wireless communication device 902 responds with a challenge response 820 that includes an ACK a duration d₂ after receiving the challenge request 818. The second wireless communication device then broadcasts isochronous data packets 822a-822d.

In some implementations, responsive to not receiving a challenge response via the backward channel within an expiration time, the first wireless communication device does not authenticate the second wireless device and may instead store the address of the second wireless communication device in a separate list, for example, an unauthenticated device list. For example, it may be that the challenge request 818a collided with another packet such as another transmission from the second wireless communication device. Alternatively, it may be that the second wireless communication device did receive the challenge request and did transmit a challenge response, but that the challenge response collided with another transmission from a neighboring device. The duration of the expiration time can be of any suitable length, for example, in the range of a few milliseconds (ms) to a few seconds, and also be randomly determined.

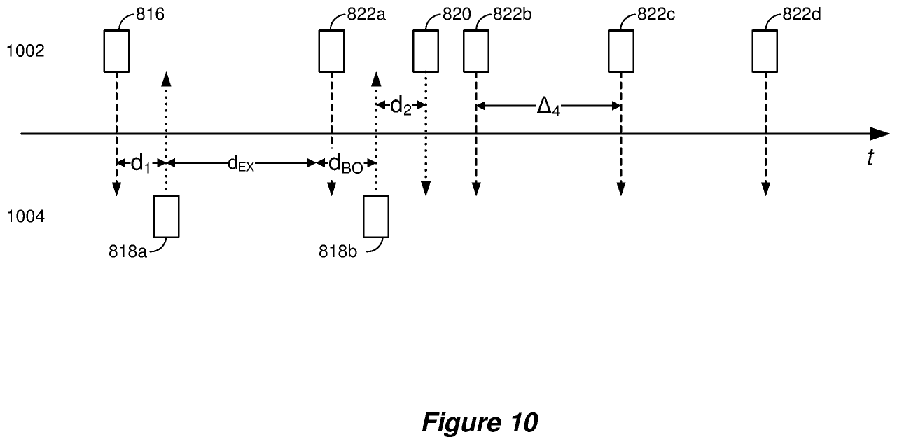

FIG. 10 shows a timing diagram 1000 illustrating transmissions between two wireless communication devices. The timing diagram 1000 is again divided into two portions to show the directions of the transmissions: all transmissions above the horizontal time axis are transmitted by the second wireless communication device (device 1002) described with reference to FIGS. 7 and 8, while all transmissions below the time axis are transmitted by the first wireless communication device (device 1004). As shown, the first wireless communication device 1004 transmits a challenge request 818a a duration d₁ after receiving a periodic advertising packet 816 transmitted by the second wireless communication device 1002. But in the illustrated scenario, the first wireless communication device 1004 does not receive a challenge response to the challenge request 818a. As just described, responsive to not receiving a challenge response via the backward channel within an expiration time, the first wireless communication device does not authenticate the second wireless device, and in some cases, may additionally store the address of the second wireless communication device in an unauthenticated device list.

In some other implementations, responsive to not receiving a challenge response via the backward channel within an expiration time d_{EX}, the first wireless communication device initiates a backoff operation. For example, at the end of the expiration time d_{EX}, the first wireless communication device may initiate a backoff timer that counts down for a duration d_{BO} (the “backoff time”). For example, the backoff time may be randomly selected. In some implementations, during the backoff timer countdown, the first wireless communication device may generate a second nonce and generate a second authentication token based on a combination of the second nonce and the portion of the synchronization information. The first wireless communication device may then generate a second secret code based on the key and the second authentication token. Responsive to the completion of the backoff timer countdown (and thus the backoff operation), the first wireless communication device may then transmit a second challenge request to the second wireless communication device via the back channel, the second challenge request including the second authentication token. This process may repeat a number of times before a challenge response is successfully received and the second wireless communication device is authenticated. In some implementations, the number of unanswered challenge requests may be limited to a threshold. As shown in FIG. 10, the first wireless communication device transmits a second challenge request 818b to the second wireless communication device which, this time, responds with a challenge response 820 that includes an ACK a duration d₂ after receiving the challenge request 818b. As described above, the first wireless communication device may then authenticate the second wireless communication device based on whether the challenge response 820 includes the correct secret code.

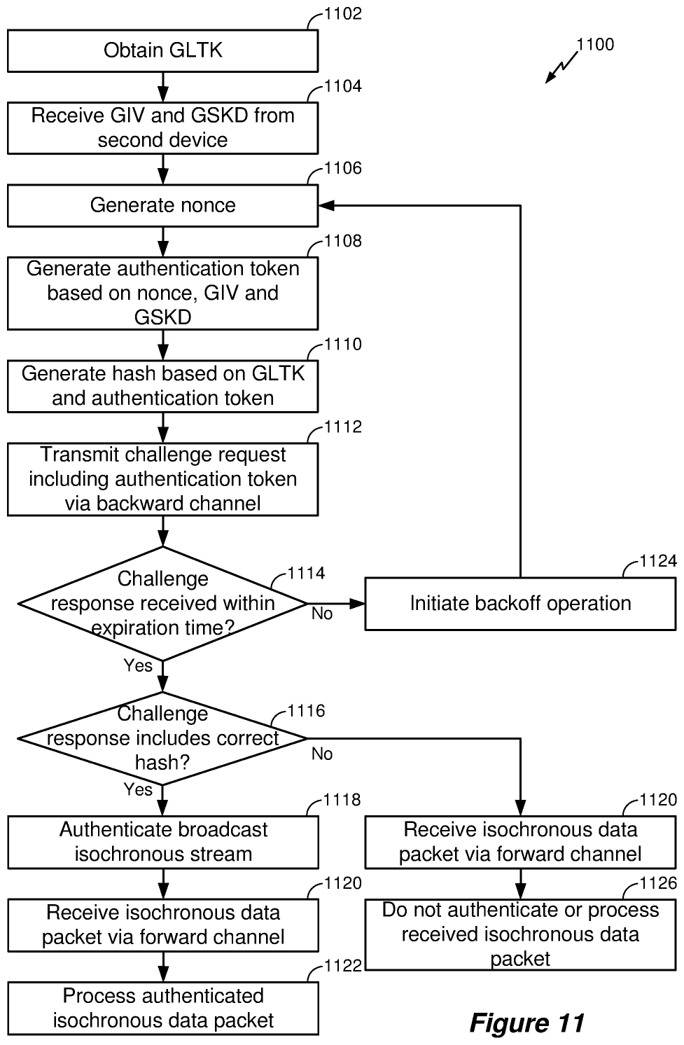

FIG. 11 shows a flowchart illustrating an example process 1100 for wireless communication by a scanning device according to some implementations. In some implementations, the process 1100 may be performed by a wireless communication device such as one of the STAs 404 or 600 described above with reference to FIGS. 4 and 6, respectively. In some implementations, the process 1000 can be implemented by a scanning device for use in receiving broadcast isochronous data from a broadcasting device in a secure manner. For example, the process 1100 may be an example implementation of the process 700 described with reference to FIG. 7.

In some implementations, the process 1100 begins in block 1102 with the scanning device obtaining a secret key—a GLTK—for broadcast isochronous communications from the broadcasting device. In some implementations, the scanning device obtains the GLTK from the broadcasting device during a previous pairing operation. In block 1104, the scanning device receives synchronization information for the BIG in at least one advertising packet via an advertising channel, the synchronization information including a GIV and a GSKD. The process 1100 proceeds in block 1106 with generating a nonce, and in block 1108, with generating an authentication token based on a combination of the nonce, the GIV and the GSKD. In block 1110, the scanning device generates a hash based on the authentication token using the GLTK. The scanning device then transmits, in block 1112, a challenge request including the authentication token to the broadcasting device via a backchannel.

Responsive to receiving a challenge response in block 1114 from the broadcasting device via the backchannel before an expiration time d_{EX} has elapsed, the scanning device determines, in block 1116, whether the challenge response includes the hash generated in block 1110. If the scanning device determines in block 1116 that the challenge response includes the correct hash, the scanning device authenticates, in block 1118, the broadcasting device and the BIS it transmits. Subsequently, responsive to receiving an isochronous data packet from the authenticated broadcasting device via a forward isochronous channel in block 1120, the scanning device processes the received isochronous data packet in block 1122 based on a source of the received isochronous data packet. For example, the scanning device determines whether the source of the received isochronous data packet is an authenticated source. The scanning device may identify the transmit address associated with the received isochronous data packet and determine whether the identified address is associated with an authenticated device based on whether the address is included in an authenticated device list. If the address identified in the received isochronous data packet matches an address in the authenticated device list, in this example the address of the broadcasting device, the scanning device authenticates and processes the received isochronous data packet in block 1122. For example, processing the received wireless communication may include decrypting, decoding or other operations.

Responsive to not receiving a challenge response in block 1114 before the expiration time d_{EX} has elapsed, the scanning device may, in block 1124 initiate a backoff operation and proceed back to block 1106 during which the scanning device generates a new nonce, and subsequently, a new authentication token a new hash and a new challenge request.

Responsive to determining, in block 1116, that the received challenge response does not include the correct hash, the scanning device does not authenticate the broadcasting device and may additionally add the broadcasting device to an unauthenticated device list. Subsequently, responsive to receiving the isochronous data packet from the broadcasting device via the forward isochronous channel in block 1120, the scanning device does not authenticate or process the received isochronous data packet.

As a person having ordinary skill in the art will appreciate, although the operations of the process 1100 are illustrated and described as ordered blocks or steps, the operations within each of the blocks may be ongoing or periodic and the blocks may overlap or otherwise be rearranged. For example, the broadcasting device may periodically transmit, and the scanning device may periodically receive, the synchronization information or the wireless communications.

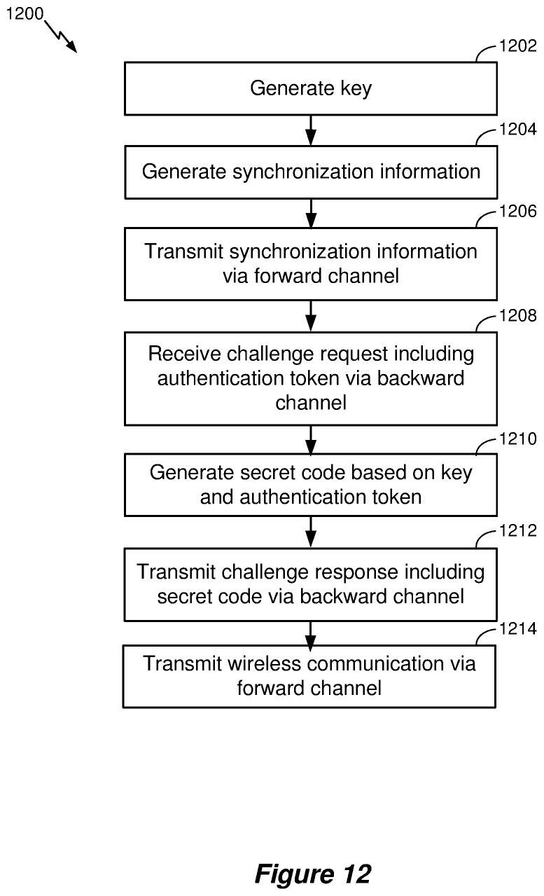

FIG. 12 shows a flowchart illustrating an example process 1200 for wireless communication by a transmitting device according to some implementations. In some implementations, the process 1200 may be performed by a wireless communication device such as one of the STAs 404 or 600 described above with reference to FIGS. 4 and 6, respectively. In some implementations, the process 1200 can be implemented by a first wireless communication device (also referred to herein as a “transmitting device” or a “broadcasting device” in some implementations) for use in broadcasting or otherwise transmitting data to a second wireless communication device (also referred to herein as a “receiving device” or a “scanning device” in some implementations) in a secure manner.

In some implementations, the process 1200 begins in block 1202 with generating a key for wireless communications. The process 1200 proceeds in block 1204 with generating synchronization information and, in block 1206, transmitting the synchronization information via a forward channel. In block 1208, the first wireless communication device receives a challenge request from a second wireless communication device via a backward channel, the challenge request including an authentication token. In some implementations, the authentication token is based on a combination of a nonce and at least a portion of the synchronization information. The process 1200 proceeds in block 1210 during which the first wireless communication device generates a secret code based on the key and the authentication token. The first wireless communication device then transmits, in block 1212, a challenge response including the authentication token to the second wireless communication device via the backchannel. In block 1214, the first wireless communication device then proceeds to transmit, or resumes the transmission of, wireless communications via a forward channel.

As a person having ordinary skill in the art will appreciate, although the operations of the process 1200 are illustrated and described as ordered blocks or steps, the operations within each of the blocks may be ongoing or periodic and the blocks may overlap or otherwise be rearranged. For example, the first wireless communication device may periodically transmit, and the second wireless communication device may periodically receive, the synchronization information or the wireless communications.

As described above, in some implementations, the first and the second wireless communication devices described with reference to FIG. 12 can be configured for broadcast isochronous communications and be part of a BIG that also may include a number of other wireless communication devices. In such implementations, the first wireless communication device may be configured to broadcast isochronous packets to the BIG including to the second wireless communication device. For example, the first wireless communication device may broadcast the wireless communications in the form of a BIS of isochronous data packets.

As described above, and as illustrated with respect to FIGS. 8-10, to enable the second wireless communication device and other devices of the BIG to receive the broadcast isochronous data packets 822, the first wireless communication device is configured to periodically broadcast the synchronization information in block 1206 in advertising packets, such as the extended advertising packets 812 and 814, and the periodic advertising packets 816. As described above, the synchronization information for the BIG generally includes information enabling any receiving devices to identify, lock onto or otherwise synchronize with the BIS to acquire the isochronous data packets 822 via the isochronous channel 810. For example, the synchronization information may include a channel map that indicates the set of PHY channels used in the piconet, a pseudo random number used as an index into the complete set of PHY channels, and the timing of the first isochronous data packet. In the example of FIG. 8, each of the extended advertising packets 812 includes synchronization information enabling scanning devices such as the second wireless communication device to identify, lock onto or otherwise synchronize with the secondary advertising channel 804 to acquire the extended advertising packets 814. Each of extended advertising packets 814 includes synchronization information enabling scanning devices such as the second wireless communication device to identify, lock onto or otherwise synchronize with the periodic advertising channel 806 to acquire periodic advertising packets 816. As described above, the synchronization information included in the periodic advertising packets 816 may include security information for the BIG such as a GIV and a GSKD. The first wireless communication device may generate the GIV and the GSKD using any suitable techniques including using a random number generator.

In some implementations, the first wireless communication device encrypts the isochronous data prior to broadcasting the isochronous data packets 822. To establish an encryption key for encrypting the isochronous data, the first wireless communication device uses the key generated in block 1202. For example, the key may be a secret key such as a GLTK. The first wireless communication device may generate the GLTK using any suitable techniques including the use of a random number generator. In some implementations, the first wireless communication device distributes the GLTK to the other devices of the BIG including the second wireless communication device during previous pairing operations with the respective devices or via any other suitable techniques. The first wireless communication device can then generate the encryption key, for example, a GSK, based on the GLTK and the GSKD for use in encrypting the broadcast isochronous data.

As described above, the authentication token included in the challenge request received in block 1208 may include a nonce and a combination of the GSKD and the GIV, for example, a concatenation of the GSKD and the GIV. In some implementations, the first wireless communication device generates the secret code in block 1210 by applying a hash function to the authentication token using the secret key. For example, the first wireless communication device may execute an identical hashing algorithm as that utilized by the second wireless communication device. The hashing algorithm may take as input the authentication token and the secret key and generate a hash of the authentication token using the secret key. In such implementations, the secret code may be, or at least be based on, the hash generated in block 1210.

As described above, and as illustrated with respect to FIGS. 8-10, the first wireless communication device receives the challenge request 818 including the authentication token from the second wireless communication device via a backchannel 810 in block 1208. The first wireless communication device may subsequently transmit the challenge response 820 including the secret code to the second wireless communication device via the backchannel in block 1212. For example, the first wireless communication device may transmit the challenge response 820 after one TIFS after receiving the challenge request. In some implementations, the challenge response 820 serves as an implicit acknowledgement (ACK) of receipt of the challenge request 818. In some other implementations, the challenge response 820 can include an explicit ACK. As described above, responsive to receiving the challenge response via the backchannel, the second wireless communication device determines whether to authenticate the first wireless communication device based on whether the challenge response includes the same secret code generated by the second wireless communication device.

As described above, in block 1214, the first wireless communication device proceeds to transmit, or resumes the transmission of, wireless communications via a forward channel. For example, the first wireless communication device may broadcast isochronous data packets 822 via the isochronous channel 810 described with reference to FIG. 8.

In some implementations, after terminating the transmission of a BIS such as that just described, the first wireless communication device may receive another challenge request from a third wireless communication device via another backchannel. The second challenge request may include a second authentication token. In such instances, the first wireless communication device may be configured to dismiss the second challenge request without responding to the second challenge request based on a determination that the BIS transmission has ended. In this way, the first wireless communication device (the transmitting device) also can protect itself against malicious devices attempting man-in-the-middle attacks or attempting to acquire information about the secret key.

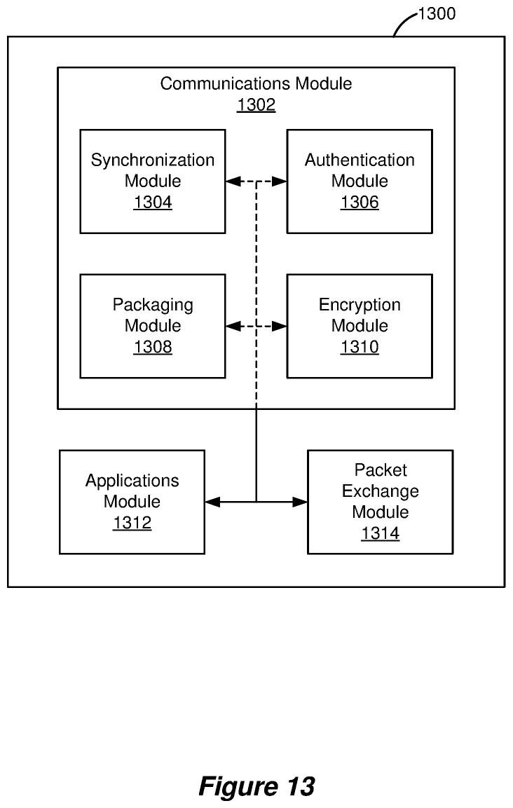

FIG. 13 shows a block diagram of an example wireless communication device 1300 according to some implementations. In some implementations, the wireless communication device 1300 can be an example of one of the STAs 404 or 600 described above with reference to FIGS. 4 and 6, respectively. In some implementations, the wireless communication device 1300 is configured to receive data broadcast or otherwise transmitted by a transmitting device in a secure manner. In some implementations, the wireless communication device 1300 is configured to perform one or both of the processes 700 or 1100 described above with reference to FIGS. 7 and 11, respectively. In some implementations, the wireless communication device 1300 is additionally configured to perform the process 1200 described above with reference to FIG. 12.

The wireless communication device 1300 includes a communications module 1302, an applications module 1312, and a packet exchange module 1314. The communications module 1302, in turn, includes a synchronization module 1304, an authentication module 1306, a packaging module 1308 and an encryption module 1310. Portions of one or more of the modules 1302, 1312 and 1314 may be implemented at least in part in hardware or firmware. For example, portions of the communications module 1302 and the packet exchange module 1314 may be implemented at least in part by one or more modems (for example, a Bluetooth modem). In some implementations, at least some of the modules 1302, 1312 and 1314 are implemented at least in part as software stored in a memory (such as the memory 320 described with reference to FIG. 3). For example, portions of one or more of the modules 1302, 1312 and 1314 can be implemented as non-transitory instructions (or “code”) executable by at least one processor (such as the processor 310 described with reference to FIG. 3) to perform the functions or operations of the respective module. In some implementations, the synchronization module 1304 may be implemented, at least in part, by a link manager (such as the link manager 604 described above with reference to FIG. 6). As another example, the authentication module 1306 may be implemented, at least in part, by a device manager (such as the device manager 602 described with reference to FIG. 6). As another example, the packaging module 1308 may be implemented, at least in part, by a baseband resource manager (such as the baseband resource manager 606 described with reference to FIG. 6). As another example, the encryption module 1310 may be implemented, at least in part, by a link controller (such as the link controller 608 described above with reference to FIG. 6). As another example, the packet exchange module 1314 may be implemented, at least in part, by a link controller and a PHY block (such as the link controller 608 and the PHY block 610 described with reference to FIG. 6).

The packet exchange module 1314 is configured to generate, transmit, receive and perform the initial processing of packets. In some implementations, the packet exchange module 1314 is configured to receive advertising packets and data packets including isochronous packets via one or more forward channels and to perform the initial processing of such packets. For example, the packet exchange module 1314 may receive periodic advertising packets that include synchronization information for a BIS via a forward channel and provide the synchronization information to the synchronization module 1304. The packet exchange module 1314 also is configured to receive data packets, such as broadcast isochronous data packets, and to provide the received data to the encryption module 1310 if encrypted or directly to the packaging module 1308 for unpackaging. In some implementations, the packet exchange module 1314 is further configured to transmit and receive packets via one or more backchannels, for example, to transmit or receive challenge requests or challenge responses.

The communications module 1302 is generally configured to manage wireless communications with a wireless network including providing for synchronization, encryption/decryption, authentication and data packaging/unpackaging. For example, the synchronization module 1304 may be configured to receive synchronization information received from the packet exchange module 1314, and to use the synchronization information to generate identification and acquisition information for acquiring data communicated via a wireless communication channel, such as isochronous data communicated via an isochronous channel in the form of a BIS. The synchronization module 1304 may provide the identification and acquisition information to the packet exchange module 1314 for use in acquiring subsequently received data. For example, in BIG implementations, the synchronization information generally includes information enabling the wireless communication device 1300 to identify, lock onto or otherwise synchronize with a BIS to acquire isochronous data packets. For example, the synchronization information may include a channel map that indicates the set of PHY channels used in the piconet, a pseudo random number used as an index into the complete set of PHY channels, and the timing of the first data packet. The synchronization information also includes security information for the BIG, such as, for example, a GIV and a GSKD.

The authentication module 1306 is configured to generate an authentication token for use in authenticating a transmitting device, such as a broadcaster of a BIS. In some implementations, the authentication module 1306 is configured to generate the authentication token based on a nonce. The authentication module 1306 may generate the nonce using a random number or based on timing information, for example, based on a timestamp, such as a global timestamp, indicating a date and time. In some implementations, the authentication module 1306 is more specifically configured to generate the authentication token based on a nonce and at least a portion of the synchronization information received from the synchronization module 1304. In some implementations, the portion of the synchronization information used to generate the authentication token includes a combination of the GSKD and the GIV, for example, a concatenation of the GSKD and the GIV. The authentication module 1306 may generate the authentication token using any suitable techniques. In one example, the authentication token may be, or may be based on, a concatenation of the nonce and the portion of the synchronization information. The authentication module 1306 is additionally configured to provide the authentication token to the packet exchange module 1314 for inclusion in a challenge request to be transmitted to the transmitting device via a backchannel.

The authentication module 1306 also is configured to generate a secret code by applying a hash function to the authentication token using a secret key (for example, a GLTK). For example, the authentication module 1306 may execute a hashing algorithm that takes as input the authentication token and the secret key and that generates a hash of the authentication token using the secret key. In such implementations, the secret code may be, or at least be based on, the hash. The authentication module 1306 is additionally configured to authenticate sources of subsequently received wireless communications such as, for example, a BIS (or the broadcaster of the BIS). In some implementations, the authentication module 1306 is configured to receive, from the packet exchange module 1314, a secret code received in a challenge response from the transmitting device via the backchannel. As described above, responsive to receiving the challenge response via the backchannel, the authentication module 1306 determines whether the secret code received in the challenge response matches the secret code it itself generated based on the authentication token and the secret key. Based on the determination, the authentication module 1306 authenticates the transmitting device. For example, based on verifying that the challenge response includes the correct secret code, the authentication module 1306 authenticates the transmitting device as an authentic transmitter of wireless communications. For example, the authentication module 1306 may authenticate that the transmitting device is not only the source of the synchronization information but also the source of the secret key. The authentication module 1306 may, after or as part of authenticating the transmitting device, store an address of the transmitting device in an authenticated device list, table or other data structure that identifies authenticated wireless devices.

The authentication module 1306 is configured to authenticate wireless communications received by the packet exchange module 1314 prior to processing by the applications module 1312. In some implementations, responsive to receiving a wireless communication via a forward channel, the authentication module 1306 identifies a source of the received wireless communication and then determines whether the source is an authenticated source. For example, the authentication module 1306 may identify the transmit address identified in the received communication and determine whether the identified address is associated with an authenticated device based on whether the address is included in the authenticated device list. If the address identified in the received wireless communication matches an address in the authenticated device list, the authentication module 1306 authenticates the received wireless communication allowing for subsequent unpackaging by the packaging module 1308 and further processing by the applications module 1312.

The packaging module 1308 is configured to unpack data received from the packet exchange module 1314 including traffic data (for example, isochronous data such as broadcast audio, video or other streaming content), synchronization information, and authentication information (for example, the secret code received in a challenge response), and to provide the unpacked data to the applications module 1312, the synchronization module 1304 and the authentication module 1306, respectively. One or both of the packet exchange module 1314 or the packaging module 1308 is further configured to identify, extract or otherwise determine the addresses of sources of received wireless communications. The address or other source information can then be passed to the authentication module 1306 so that the authentication module can determine whether the source is an authenticated source.

The encryption module 1310 is configured to encrypt and decrypt wireless communications. The encryption module 1310 may be configured to obtain a secret key, such as a GLTK. In some implementations, the encryption module 1310 receives the GLTK as a result of a previous pairing operation with a transmitting device or via any other suitable techniques. The encryption module 1310 may generate an encryption key, a GSK, for use in decrypting broadcast isochronous data based on the GLTK and a GSKD obtained from the synchronization module 1304.

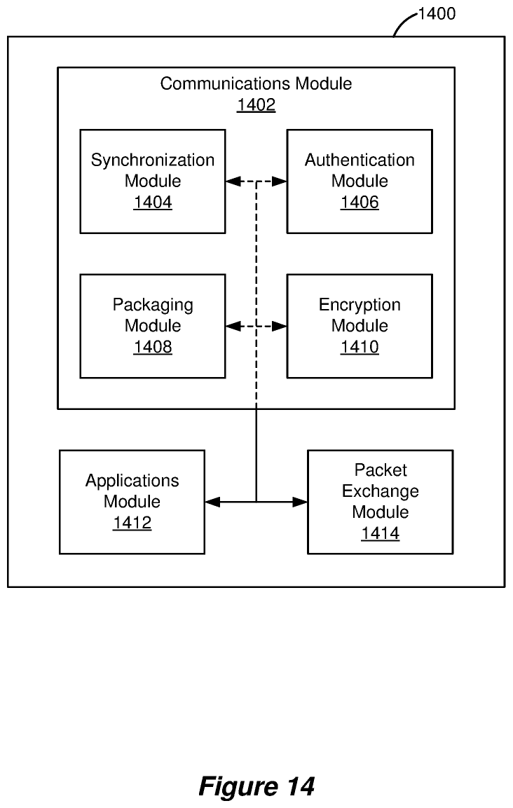

FIG. 14 shows a block diagram of an example wireless communication device 1400 according to some implementations. In some implementations, the wireless communication device 1400 can be an example of one of the STAs 404 or 600 described above with reference to FIGS. 4 and 6, respectively. In some implementations, the wireless communication device 1400 is configured to broadcast or otherwise transmit data in a secure manner. In some implementations, the wireless communication device 1400 is configured to perform the process 1200 described above with reference to FIG. 12. In some implementations, the wireless communication device 1400 is additionally configured to perform one or both of the processes 700 or 1100 described above with reference to FIGS. 7 and 11, respectively.

The wireless communication device 1400 includes a communications module 1402, an applications module 1412, and a packet exchange module 1414. The communications module 1402, in turn, includes a synchronization module 1404, an authentication module 1406, a packaging module 1408 and an encryption module 1410. Portions of one or more of the modules 1402, 1412 and 1414 may be implemented at least in part in hardware or firmware. For example, portions of the communications module 1402 and the packet exchange module 1414 may be implemented at least in part by one or more modems (for example, a Bluetooth modem). In some implementations, at least some of the modules 1402, 1412 and 1414 are implemented at least in part as software stored in a memory (such as the memory 320 described with reference to FIG. 3). For example, portions of one or more of the modules 1402, 1412 and 1414 can be implemented as non-transitory instructions (or “code”) executable by at least one processor (such as the processor 310 described with reference to FIG. 3) to perform the functions or operations of the respective module. In some implementations, the synchronization module 1404 may be implemented, at least in part, by a link manager (such as the link manager 604 described above with reference to FIG. 6). As another example, the authentication module 1406 may be implemented, at least in part, by a device manager (such as the device manager 602 described with reference to FIG. 6). As another example, the packaging module 1408 may be implemented, at least in part, by a baseband resource manager (such as the baseband resource manager 606 described with reference to FIG. 6). As another example, the encryption module 1410 may be implemented, at least in part, by a link controller (such as the link controller 608 described above with reference to FIG. 6). As another example, the packet exchange module 1414 may be implemented, at least in part, by a link controller and a PHY block (such as the link controller 608 and the PHY block 610 described with reference to FIG. 6).

The packet exchange module 1414 is configured to generate, transmit, receive and perform the initial processing of packets. In some implementations, the packet exchange module 1414 is configured to generate and transmit advertising packets and data packets including isochronous packets via one or more forward channels. For example, the packet exchange module 1414 may receive synchronization information from the synchronization module 1404 and transmit periodic advertising packets that include synchronization information for a BIS via a forward channel. The packet exchange module 1414 also is configured to generate data packets, such as broadcast isochronous data packets, using data packaged by the packaging module 1408. In some implementations, the packet exchange module 1414 is further configured to transmit and receive packets via one or more backchannels, for example, to transmit or receive challenge requests or challenge responses.

The communications module 1402 is generally configured to manage wireless communications with a wireless network including providing for synchronization, encryption/decryption, authentication and data packaging/unpackaging. For example, the synchronization module 1404 may be configured to generate synchronization information and to provide the synchronization information to the packaging module 1408 or packet exchange module 1414 for transmission to the wireless network. For example, in BIG implementations, the synchronization information generally includes information enabling a receiving device to identify, lock onto or otherwise synchronize with a BIS to acquire isochronous data packets. For example, the synchronization information may include a channel map that indicates the set of PHY channels used in the piconet, a pseudo random number used as an index into the complete set of PHY channels, and the timing of the first data packet. The synchronization information also includes security information for the BIG, such as, for example, a GIV and a GSKD. The synchronization module 1404 may generate the synchronization information, including the GIV and the GSKD, using any suitable techniques including using a random number generator.

The authentication module 1406 is configured to receive a challenge request from a receiving device via a backchannel and to extract an authentication token from the challenge request. The authentication module 1406 also is configured to generate a secret code by applying a hash function to the authentication token using a secret key (for example, a GLTK). For example, the authentication module 1406 may execute a hashing algorithm that takes as input the authentication token and the secret key and that generates a hash of the authentication token using the secret key. In such implementations, the secret code may be, or at least be based on, the hash. The authentication module 1406 is additionally configured to generate a challenge response, including the secret code, and to provide the challenge response to the packet exchange module 1414 for transmission to the receiving device via the backchannel.

The applications module 1406 is configured to generate, relay or otherwise provide data (such as broadcast data including audio, video or other streaming content) from one or more applications executing on a processor to the packaging module 1408. The packaging module 1408 is configured to collect, aggregate, divide or otherwise package the data received from the applications module 1412. The packaging module 1408 is also responsible for scheduling the transmission of the packaged data and for providing the scheduled data to the encryption module 1410 for subsequent encryption or directly to the packet exchange module 1414 for packetizing and transmission to the wireless network.

The encryption module 1410 is configured to encrypt data, such as isochronous data, received from the packaging module 1108. For example, to establish an encryption key for a BIS, the encryption module 1410 generates a secret key, such as a GLTK. The encryption module 1410 generates an encryption key, a GSK, based on the GLTK and the GSKD for use in encrypting the broadcast isochronous data from the applications module 1406 prior to packetizing and transmission by the packet exchange module 1414.

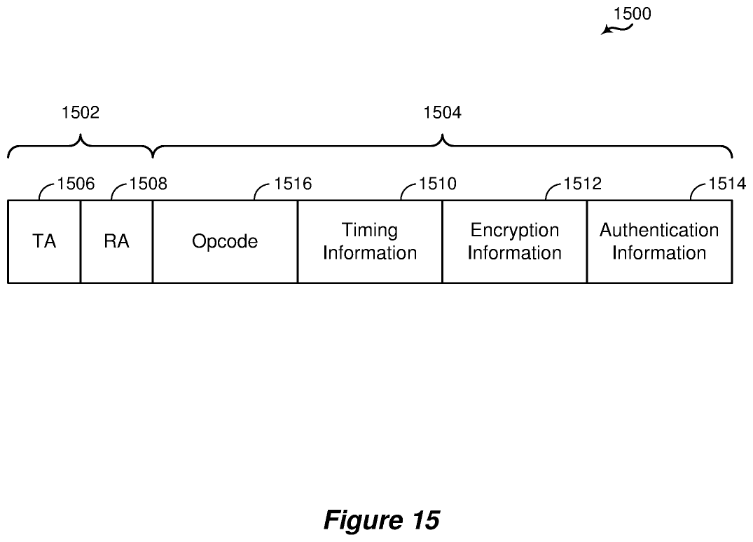

FIG. 15 shows an example protocol data unit (PDU) 1500 usable for communicating via a backchannel according to some implementations. For example, the PDU 1500 may be used by the first wireless communication device (the receiving device) to transmit the challenge request including the authentication token to the second wireless communication device (the transmitting device) in block 712 of the process 700 described with reference to FIGS. 7-10. The PDU 1500 also may be an example of a packet format suitable for use by the transmitting device to transmit the challenge response including the secret code to the receiving device in block 1212 of the process 1200 described with reference to FIG. 12. The PDU 1500 includes a header 1502 and a data field 1504 that includes the authentication token in the case of a challenge request, and a secret code in the case of a challenge response. The header 1502 includes a transmit address field 1506 identifying the transmitter of the PDU 1500. The header 1502 also may include a receive address field 1508 identifying a target of the PDU 1500. In some implementations, the data field 1504 itself includes a number of fields (or “sub-fields”) as well including, for example, a timing field 1510, an encryption field 1512 and an authentication field 1514. The timing field 1510 may include a timestamp, for example, identifying the current date and time, and in some instances, the current time zone. The encryption field 1512 can include encryption information, for example, at least a portion of the synchronization information (such as a concatenation of the GIV and the GSKD for a BIG). The authentication field 1514 includes the authentication token or secret code. The PDU 1500 also can include an opcode field 1516 that includes an authentication indicator indicating that the subsequent data in the data field 1504 is authentication information (the authentication token or secret code). In some implementations, each of the timing field 1510, the encryption field 1512 and the authentication field 1514 is encrypted using an encryption key (such as a GSK).

As used herein, a phrase referring to “at least one of” or “one or more of” a list of items refers to any combination of those items, including single members. For example, “at least one of: a, b, or c” is intended to cover the possibilities of: a only, b only, c only, a combination of a and b but not c, a combination of a and c but not b, a combination of b and c but not a, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some implementations, particular processes, operations and methods may be performed by circuitry that is specific to a given function.

As described above, in some aspects implementations of the subject matter described in this specification can be implemented as software. For example, various functions of components disclosed herein or various blocks or steps of a method, operation, process or algorithm disclosed herein can be implemented as one or more modules of one or more computer programs. Such computer programs can include non-transitory processor- or computer-executable instructions encoded on one or more tangible processor- or computer-readable storage media for execution by, or to control the operation of, data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

What is claimed is:

1. A method for wireless communication by a wireless communication device, comprising:
obtaining a key for wireless communications;
receiving synchronization information from a second wireless communication device via a forward channel;
generating a nonce;
generating an authentication token based on a combination of the nonce and at least a portion of the synchronization information;
generating a secret code based on the key and the authentication token;
transmitting a challenge request to the second wireless communication device via a backward channel, the challenge request including the authentication token;
responsive to receiving a challenge response from the second wireless communication device via the backward channel:
determining whether the challenge response includes the secret code, and
authenticating the second wireless communication device based on the determination; and
responsive to receiving a wireless communication from the second wireless communication device via a forward channel, processing the received wireless communication based on the result of the authentication.

2. The method of claim 1, wherein the wireless communications are broadcast isochronous packets and wherein receiving the at least one wireless communication includes synchronizing, based on the synchronization information, with a broadcast isochronous stream to receive at least one broadcast isochronous packet.

3. The method of claim 2, wherein the key is a Group Long Term Key (GLTK), and wherein the portion of the synchronization information includes a Group Session Key Diversifier (GSKD) and a Group Initialization Vector (GIV).

4. The method of claim 3, wherein generating the authentication token based on the combination of the nonce and the portion of the synchronization information includes forming a concatenation of the nonce, the GSKD and the GIV.

5. The method of claim 3, wherein generating the secret code based on the key and the authentication token includes hashing the authentication token with a hash function using the GLTK to generate a hash, the secret code being, or being based on, the hash.

6. The method of claim 3, wherein the received at least one wireless communication is encrypted, the method further including:
generating a Group Session Key (GSK) for the wireless communications based on the GLTK and the GSKD; and
decrypting the received at least one wireless communication using the GSK.

7. The method of claim 2, wherein the forward channel is an isochronous channel and wherein receiving the synchronization information includes receiving the synchronization information in at least one periodic advertising packet transmitted via a secondary advertising channel.

8. The method of claim 1, wherein, responsive to not receiving the challenge response via the backward channel within an expiration time, the method further includes:
initiating a backoff operation;
generating a second nonce;
generating a second authentication token based on a combination of the second nonce and at least the portion of the synchronization information;
generating a second secret code based on the key and the second authentication token; and
responsive to the completion of the backoff operation, transmitting a second challenge request to the second wireless communication device via the backward channel, the second challenge request including the second authentication token.

9. A wireless communication device comprising:
at least one processor; and
at least one memory communicatively coupled with the at least one processor and storing processor-readable code that, when executed by the at least one processor, causes the wireless communication device to:
obtain a key for wireless communications;
receive synchronization information from a second wireless communication device via a forward channel;
generate a nonce;
generate an authentication token based on a combination of the nonce and at least a portion of the synchronization information;
generate a secret code based on the key and the authentication token;
transmit a challenge request to the second wireless communication device via a backward channel, the challenge request including the authentication token;
responsive to receiving a challenge response from the second wireless communication device via the backward channel:
determine whether the challenge response includes the secret code, and
authenticate the second wireless communication device based on the determination; and
responsive to receiving a wireless communication from the second wireless communication device via a forward channel, process the received wireless communication based on the result of the authentication.

10. The wireless communication device of claim 9, wherein the wireless communications are broadcast isochronous packets and wherein to receive the at least one wireless communication the code is configured to, when executed by the at least one processor, cause the wireless communication device to synchronize, based on the synchronization information, with a broadcast isochronous stream to receive at least one broadcast isochronous packet.

11. The wireless communication device of claim 10, wherein the key is a Group Long Term Key (GLTK), and wherein the portion of the synchronization information includes a Group Session Key Diversifier (GSKD) and a Group Initialization Vector (GIV).

12. The wireless communication device of claim 11, wherein to generate the authentication token based on the combination of the nonce and the portion of the synchronization information includes forming a concatenation of the nonce, the GSKD and the GIV.

13. The wireless communication device of claim 11, wherein to generate the secret code based on the key and the authentication token, the code is configured to, when executed by the at least one processor, cause the wireless communication device to hash the authentication token with a hash function using the GLTK to generate a hash, the secret code being, or being based on, the hash.

14. The wireless communication device of claim 11, wherein the received at least one wireless communication is encrypted, and wherein the code is further configured to, when executed by the at least one processor, cause the wireless communication device to:
generate a Group Session Key (GSK) for the wireless communications based on the GLTK and the GSKD; and
decrypt the received at least one wireless communication using the GSK.

15. The wireless communication device of claim 10, wherein the forward channel is an isochronous channel and wherein the synchronization information is received in at least one periodic advertising packet transmitted via a secondary advertising channel.

16. The wireless communication device of claim 9, wherein, responsive to not receiving the challenge response via the backward channel within an expiration time, the code is further configured to, when executed by the at least one processor, cause the wireless communication device to:
initiate a backoff operation;
generate a second nonce;
generate a second authentication token based on a combination of the second nonce and at least the portion of the synchronization information;
generate a second secret code based on the key and the second authentication token; and
responsive to the completion of the backoff operation, transmit a second challenge request to the second wireless communication device via the backward channel, the second challenge request including the second authentication token.

17. A method for wireless communication by a first wireless communication device, comprising:
generating a key for wireless communications;
generating synchronization information for the wireless communications;
transmitting the synchronization information via a forward channel;
receiving a challenge request from a second wireless communication device via a backward channel, the challenge request including an authentication token, the authentication token being based on a combination of a nonce and at least a portion of the synchronization information;
generating a secret code based on the key and the authentication token;
transmitting a challenge response that includes the secret code to the second wireless communication device via the backward channel; and
transmitting at least one wireless communication via a forward channel.

18. The method of claim 17, wherein the wireless communications are broadcast isochronous packets and wherein transmitting the at least one wireless communication includes transmitting a broadcast isochronous stream including at least one broadcast isochronous packet.

19. The method of claim 18, wherein the key is a Group Long Term Key (GLTK), and wherein the portion of the synchronization information includes a Group Session Key Diversifier (GSKD) and a Group Initialization Vector (GIV).

20. The method of claim 19, wherein generating the secret code based on the key and the authentication token includes hashing the authentication token with a hash function using the GLTK to generate a hash, the secret code being, or being based on, the hash.

21. The method of claim 19, further including:
generating a Group Session Key (GSK) for the wireless communications based on the GLTK and the GSKD; and
encrypting the at least one wireless communication using the GSK prior to transmitting the at least one wireless communication.

22. The method of claim 18, wherein the forward channel is an isochronous channel and wherein transmitting the synchronization information includes transmitting the synchronization information in at least one periodic advertising packet via a secondary advertising channel.

23. The method of claim 18, further including:
ending the transmission of the broadcast isochronous stream;
at a time after the end of the transmission, receiving a second challenge request from a third wireless communication device via a second backward channel, the second challenge request including a second authentication token; and
dismissing the second challenge request without responding to the second challenge request based on a determination that the transmission has ended.

24. The method of claim 17, wherein the challenge response further includes an acknowledgement (ACK) of the challenge request.

25. A wireless communication device comprising:
at least one processor; and
at least one memory communicatively coupled with the at least one processor and storing processor-readable code that, when executed by the at least one processor, causes the wireless communication device to:
generate a key for wireless communications;
generate synchronization information for the wireless communications;
transmit the synchronization information via a forward channel;
receive a challenge request from a second wireless communication device via a backward channel, the challenge request including an authentication token, the authentication token being based on a combination of a nonce and at least a portion of the synchronization information;
generate a secret code based on the key and the authentication token;
transmit a challenge response that includes the secret code to the second wireless communication device via the backward channel; and
transmit at least one wireless communication via a forward channel.

26. The wireless communication device of claim 25, wherein the wireless communications are broadcast isochronous packets and wherein to transmit the at least one wireless communication the code is configured to, when executed by the at least one processor, cause the wireless communication device to transmit a broadcast isochronous stream including at least one broadcast isochronous packet.

27. The wireless communication device of claim 26, wherein the key is a Group Long Term Key (GLTK), and wherein the portion of the synchronization information includes a Group Session Key Diversifier (GSKD) and a Group Initialization Vector (GIV).

28. The wireless communication device of claim 27, wherein to generate the secret code based on the key and the authentication token the code is configured to, when executed by the at least one processor, cause the wireless communication device to hash the authentication token with a hash function using the GLTK to generate a hash, the secret code being, or being based on, the hash.

29. The wireless communication device of claim 27, wherein the code is configured to, when executed by the at least one processor, cause the wireless communication device to:
generate a Group Session Key (GSK) for the wireless communications based on the GLTK and the GSKD; and
encrypt the at least one wireless communication using the GSK prior to transmitting the at least one wireless communication.

30. The wireless communication device of claim 26, wherein the forward channel is an isochronous channel and wherein to transmit the synchronization information the code is configured to, when executed by the at least one processor, cause the wireless communication device to transmit the synchronization information in at least one periodic advertising packet via a secondary advertising channel.

31. The wireless communication device of claim 26, wherein the code is further configured to, when executed by the at least one processor, cause the wireless communication device to:
end the transmission of the broadcast isochronous stream;
at a time after the end of the transmission, receive a second challenge request from a third wireless communication device via a second backward channel, the second challenge request including a second authentication token; and
dismiss the second challenge request without responding to the second challenge request based on a determination that the transmission has ended.

32. The wireless communication device of claim 25, wherein the challenge response further includes an acknowledgement (ACK) of the challenge request.
